(19) United States
(12) Patent Application Publication
(10) Pub. No.: US 2025/0233771 A1
(43) Pub. Date: Jul. 17, 2025

(54) SYSTEM AND METHOD FOR TRANSMISSION OF PRIMARY AND SECONDARY DATA IN A COMMUNICATIONS NETWORK

(71) Applicant: Cirrus Logic International Semiconductor Ltd., Edinburgh (GB)

(72) Inventors: Michael CHANDLER-PAGE, Newbury (GB); Jack FULLER, Newbury (GB); Amr ELSLEHDAR, Newbury (GB)

(73) Assignee: Cirrus Logic International Semiconductor Ltd., Edinburgh (GB)

(21) Appl. No.: 19/013,618

(22) Filed: Jan. 8, 2025

Related U.S. Application Data
(60) Provisional application No. 63/683,965, filed on Aug. 16, 2024.
(60) Provisional application No. 63/621,255, filed on Jan. 16, 2024.

(51) Int. Cl. H04L 12/43; H04L 12/28; H04L 12/40

(52) U.S. Cl. CPC H04L 12/43; H04L 12/40; H04L 12/2881

(57) ABSTRACT

A system for transmission of primary and secondary data, the system comprising: a bus; a parent node coupled to the bus; and a plurality of child nodes, each coupled to the bus, wherein: the parent node is configured to periodically transmit a time domain multiplexing (TDM) cycle beacon to the bus, wherein the TDM cycle beacon signals a start of a primary data transmission interval, and wherein the primary data transmission interval is a period reserved for transmission of primary data by the parent node and the plurality of child nodes; the parent node and each of the plurality of child nodes are operable to, responsive to the TDM cycle beacon, transmit primary data for a current TDM beacon period associated with the TDM cycle beacon to the bus during the primary data transmission interval; and the parent node and the plurality of child nodes are operable to transmit secondary data to the bus during a secondary data transmission interval between an end of the primary transmission interval and transmission by the parent node of a next TDM cycle beacon.

### FIELD OF THE INVENTION

The present disclosure relates to a system and method for transmission of primary and secondary data in a communications network.

### BACKGROUND

There is an increasing trend in a wide range of industrial applications for embedded electronic systems. Such applications may benefit from a relatively simple, integrated and low-latency communication system that provides for improved efficiency and ease of use when installing, using and maintaining such a communication system.

### SUMMARY

According to a first aspect, the invention provides a system for transmission of primary and secondary data, the system comprising: a bus; a parent node coupled to the bus; and a plurality of child nodes, each coupled to the bus, wherein: the parent node is configured to periodically transmit a time domain multiplexing (TDM) cycle beacon to the bus, wherein the TDM cycle beacon signals a start of a primary data transmission interval, and wherein the primary data transmission interval is a period reserved for transmission of primary data by the parent node and the plurality of child nodes; the parent node and each of the plurality of child nodes are operable to, responsive to the TDM cycle beacon, transmit primary data for a current TDM beacon period associated with the TDM cycle beacon to the bus during the primary data transmission interval; and the parent node and the plurality of child nodes are operable to transmit secondary data to the bus during a secondary data transmission interval between an end of the primary transmission interval and transmission by the parent node of a next TDM cycle beacon.

The primary data may be of a higher priority than the secondary data.

The primary data may be isochronous data associated with a first latency requirement. The secondary data may be associated with a second latency requirement. The first latency requirement may be more stringent than the second latency requirement.

The parent node may be further configured to transmit a data cycle beacon in place of the TDM cycle beacon, wherein the data cycle beacon signals: a start of a primary data transmission interval; and a start of a secondary data frame cycle, wherein the secondary data frame cycle provides an opportunity for the parent node and each of the plurality of child nodes to transmit one frame of secondary data to the bus.

The primary data may comprise audio data. The secondary data may comprise Ethernet data.

The parent node may be configured to transmit one TDM cycle beacon per sample period of the audio data.

The TDM cycle beacon may comprise a first particular combination of symbols used in 10Base-T1S Ethernet.

The parent node and each of the plurality of child nodes may each be configured to transmit their primary data in a respective primary data microframe.

The primary data microframe may comprises: a header; one or more data samples of primary data for a current TDM beacon period; and an end-of-frame delimiter.

The primary data microframe may further comprise a scrambler synchronisation sequence.

The header may comprise a second particular combination of symbols used in 10Base-T1S Ethernet.

The parent node and the plurality of child nodes may each be configured to transmit their respective primary data microframes in a predefined primary data transmission order.

The parent node and the plurality of child nodes may be configured to implement a minimum delay between transmission of the TDM cycle beacon and transmission of the primary data frame of the parent node and between transmission of their respective primary data microframes in the predefined primary transmission order.

The parent node and the plurality of child nodes may be configured to implement a random or pseudo-random delay between transmission of their respective primary microframes.

The parent node and each of the plurality of child nodes may be operative to determine a correct point within the primary data transmission interval at which to transmit its primary data microframe by determining: a byte or time offset from the TDM cycle beacon; or a number of transmissions on the bus that have occurred since the transmission of the TDM cycle beacon.

The parent node and each of the plurality of child nodes may be operative to transmit a Yield signal to the bus if they do not have a frame of secondary data to transmit.

The secondary data frame cycle may provide a respective transmit opportunity window for the parent node and each of the plurality of child nodes within which the parent node or the child node may transmit one frame of secondary data to the bus. The parent node and each of the plurality of child nodes may each be operative to maintain correct timing of transmission of their respective secondary data frames.

The secondary data frame cycle may provide a respective transmit opportunity window for the parent node and each of the plurality of child nodes within which the parent node or the child node may transmit one frame of secondary data to the bus. The parent node and each of the plurality of child nodes may include a transmit opportunity counter operative to count transmit opportunities since the transmission of the data cycle beacon. Each of the plurality of child nodes may be operative to determine when to transmit its respective frame of secondary data based on a value of its respective transmit opportunity counter. the parent node and each of the plurality of child nodes may be operative to adjust its respective transmit opportunity counter responsive to transmission of a frame of secondary data by the parent node or a child node. Each of the plurality of child nodes may be operative to transmit no signal to the bus if it does not have a frame of secondary data to transmit. The parent node may be operative, on detection that a transmit opportunity window has elapsed without a frame of secondary data being transmitted, to transmit a Transmit Opportunity Increment signal to the bus. Each of the plurality of child nodes may be operative to adjust its respective transmit opportunity counter responsive to detection of a Transmit Opportunity Increment signal.

The parent node may be operative, if the transmit opportunity window will elapse within a predefined period before a scheduled transmission of a next TDM cycle beacon, to delay transmission of the Transmit Opportunity Increment signal until after the end of the primary data transmission interval of a next TDM cycle period associated with the next TDM cycle beacon.

The parent node may be operative, responsive to its transmit opportunity counter reaching a predefined value, not to transmit the Transmit Opportunity Increment signal and to transmit a new data cycle beacon in place of a next TDM cycle beacon.

The data cycle beacon may comprise a third particular combination of symbols used in 10Base-T1S Ethernet.

A node transmitting a frame of secondary data may be operative to split the frame of secondary data over a plurality of TDM beacon periods if a length of the frame of secondary data is greater than a length of the secondary data transmission interval.

The node transmitting the frame of secondary data may be operative to: suspend transmission of the frame of secondary data; and resume transmission of the frame of secondary data after the end of the primary transmission period of a next TDM beacon period.

The node transmitting a frame of secondary data may be operative to suspend transmission of the frame of secondary data on an octet boundary thereof.

The node transmitting the frame of secondary data may be operative to: transmit a suspend signal comprising a fourth particular combination of symbols used in 10Base-T1S Ethernet to signal suspension of the transmission of the frame of secondary data; and transmit a resume signal comprising a fifth particular combination of symbols used in 10Base-T1S Ethernet in the next TDM beacon period to signal resumption of the transmission of the frame of secondary data.

The parent node and the plurality of child nodes may be configured to implement a random or pseudo-random delay to a transmission timing of their respective secondary data frames.

The parent node may be operative to apply a random or pseudo-random delay to a transmission of a TDM beacon signal.

The parent node may be operative to associate a randomisation value indicative of a duration of the random or pseudo-random delay with the TDM beacon signal.

The random or pseudo-random delay may be based on a random probability density function (RPDF) or a triangular probability density function (TPDF) with a variable amplitude.

The parent node and/or at least one of the plurality of child nodes may comprise a clock recovery system configured to generate a clock signal based on the TDM cycle beacon signal and/or the data cycle beacon.

The clock recovery system may be configured to generate a TDM Cycle Beacon Detect signal responsive to detection of the TDM cycle beacon or the data cycle beacon. The clock recovery system may comprise a phase-locked loop (PLL) configured to use the TDM Cycle Beacon Detect signal as a frequency and phase reference to generate the clock signal.

The communications network may comprise a multi-drop communications network.

The bus may comprise a twisted pair cable.

The bus may be configured to transmit power to one or more of the plurality of child nodes.

According to a second aspect, the invention provides a road noise cancellation system comprising the system of the first aspect, wherein at least one of the plurality of child nodes comprises a microphone node or an accelerometer node, and wherein the primary data comprises road noise cancellation audio sample data generated by the microphone node or accelerometer data generated by the accelerometer node.

According to a third aspect, the invention provides a method for transmission of primary and secondary data in a communications network comprising a bus, a parent node coupled to the bus, and a plurality of child nodes coupled to the bus, the method comprising: periodically broadcasting a TDM cycle beacon signal by the parent node, the TDM cycle beacon signal defining a start of a primary data transmission interval, wherein the primary data transmission interval is a period reserved for transmission of primary data by the parent node and the plurality of child nodes; responsive to the TDM cycle beacon signal, the parent node and/or at least one of the plurality of child nodes transmitting primary data to the bus during the primary data transmission interval; and providing a secondary data transmission interval between expiry of the primary data transmission interval and broadcast by the parent node of a next TDM cycle beacon signal, the secondary data transmission interval being a period reserved for transmission of secondary data by the parent nodes and/or the plurality of child nodes.

According to a fourth aspect, the invention provides an isochronous data transceiver for a node of the system of the first aspect, wherein the isochronous data transceiver comprises: processing circuitry implementing a framing engine comprising a primary data microframe handler and a secondary data frame handler; and interface circuitry for interfacing the isochronous data transceiver with the bus of the system, wherein: the primary data microframe handler is configured to transmit and receive primary data microframes to and from the bus via the interface circuitry; the secondary data frame handler is configured to transmit and receive secondary data frames to and from the bus via the interface circuitry; and the framing engine is operable to generate and transmit the TDM cycle beacon to the bus.

The isochronous data transceiver may be configured to receive the TDM cycle beacon and/or a data cycle beacon and to generate a clock signal based on the TDM cycle beacon signal and/or the data cycle beacon.

The isochronous data may comprise audio data.

According to a fifth aspect, the invention provides an integrated circuit (IC) implementing the isochronous data transceiver of the fourth aspect.

The IC may further comprise amplifier circuitry.

According to a sixth aspect, the invention provides a parent node or a child node of a communications network comprising the isochronous data transceiver of the fourth aspect.

According to a seventh aspect, the invention provides integrated circuitry integrating a parent node for the system of the first aspect, wherein the integrated circuitry is operative to: apply a random or pseudo-random delay to a transmission of a TDM beacon signal; and associate a randomisation value indicative of a duration of the random or pseudo-random delay with the TDM beacon signal.

According to an eighth aspect, the invention provides integrated circuitry integrating a child node for the system of the first aspect, wherein the integrated circuitry is operative to: receive a TDM beacon signal having a random or pseudo-random delay and an associated randomisation value; and generate a reference clock signal based on the received TDM beacon signal using the randomisation value to compensate for the random or pseudo-random delay of the beacon signal.

According to a ninth aspect, the invention provides a vehicle comprising the system of the first aspect.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of an example multi-drop communications network in which the system and method of the present disclosure may be implemented;

FIG. 2 is a schematic representation of a beacon-based transmission scheme used for transmission of primary data and secondary data in the example multi-drop communications network 100 of FIG. 1;

FIG. 3a is a schematic diagram showing an example structure of a TDM cycle beacon and a primary data microframe used in the beacon-based transmission scheme of FIG. 2;

FIG. 3b illustrates a multi-rate primary data microframe;

FIG. 4 is a schematic representation of the beacon-based transmission scheme of FIG. 2, showing transmission of secondary data as well as primary data;

FIG. 5a is a schematic representation of the beacon-based transmission scheme of FIG. 2, showing transmission of a frame of secondary data over a plurality of beacon intervals;

FIG. 5b illustrates a secondary data frame transmitted in the same way as a 10Base-T1S/IEEE802.3cg-compliant Ethernet frame;

FIG. 5c illustrates transmission of partial secondary data frames with suspend and resume symbol combinations;

FIG. 6 is a schematic representation of the beacon-based transmission scheme of FIG. 2, showing transmit opportunity windows in which no frame of secondary data is transmitted;

FIG. 7 is a schematic diagram illustrating recovery of an audio sample clock from transmitted TDM beacons;

FIG. 8 is a schematic representation of an audio transceiver system that may be used in nodes of the multi-drop communications network of FIG. 1;

FIG. 9 is a schematic representation of an audio transceiver integrated circuit implementation of the audio transceiver system of FIG. 8;

FIG. 10 is a schematic representation of a combined amplifier and audio transceiver integrated circuit implementation of the audio transceiver system of FIG. 8;

FIG. 11 is a schematic representation of integrated circuitry implementing a parent node; and

FIG. 12 is a schematic representation of integrated circuitry implementing a child node.

### DETAILED DESCRIPTION

One example of an application in which the provision of a relatively simple, integrated and low-latency communication system may be beneficial is in embedded electronic systems in vehicles, for example multi-speaker audio or infotainment systems.

Such systems can be used to transmit audio signals representing music or other audio content from a central node to remote speakers. Such systems may also be used for other purposes such as road noise cancellation.

In a road noise cancellation (RNC) system, one or more microphone nodes, each comprising a microphone and related electronic circuitry (e.g. signal processing circuitry, analog to digital converter circuitry, network interface circuitry and the like) and one or more accelerometer nodes, each comprising an accelerometer and related electronic circuitry (e.g. signal processing circuitry, network interface circuitry and the like) are positioned in the vicinity of sources of road noise within zones a vehicle, e.g. in zones that are in proximity to the wheels of the vehicle. The microphone nodes transmit audio signals representing detected road noise to a central node. The accelerometer nodes transmit accelerometer data signals representing detected vibration or other motion to the central node. The central node generates a noise cancellation signal for each zone of the vehicle, and transmits the noise cancellation signal to one or more speakers within the respective zone of the vehicle for output by the speaker. In this way, the perception of road noise by an occupant of the vehicle may be reduced.

Systems such as RNC systems require very low latency audio and accelerometer data signal paths, as noise reduction signals must be generated and transmitted to the relevant speaker in less time than it takes for sound to propagate from a road noise source to the vehicle occupant's ear.

Some vehicle audio systems transmit audio signals over an in-vehicle Ethernet network using known Ethernet data transfer protocols. For RNC, however, the latency of existing Ethernet data transmission protocols is too great for effective cancellation or reduction of road noise.

Similar considerations may apply to other applications that require low-latency transmission of data, such as so-called “drive by wire” systems in which control signals for controlling operation of vehicle systems such as a throttle, steering or braking system may be transmitted over an in-vehicle network.

Thus, it would be desirable to provide a communication system for transmission of high-priority primary data such as RNC or drive by wire control signals with low latency in addition to lower priority secondary data having less stringent latency requirements, such as control signals for vehicle body and cabin electronics functions such as lighting control, seat controls, heating, ventilation and air conditioning (HVAC) control and window actuators. Permitting the transmission of secondary data over the same communication system as primary data permits a reduction in the, weight and complexity, in comparison to an arrangement that provides a first communication system for primary data and a second, separate, communication system for secondary data.

The system and method of the present disclosure provide such a communication system.

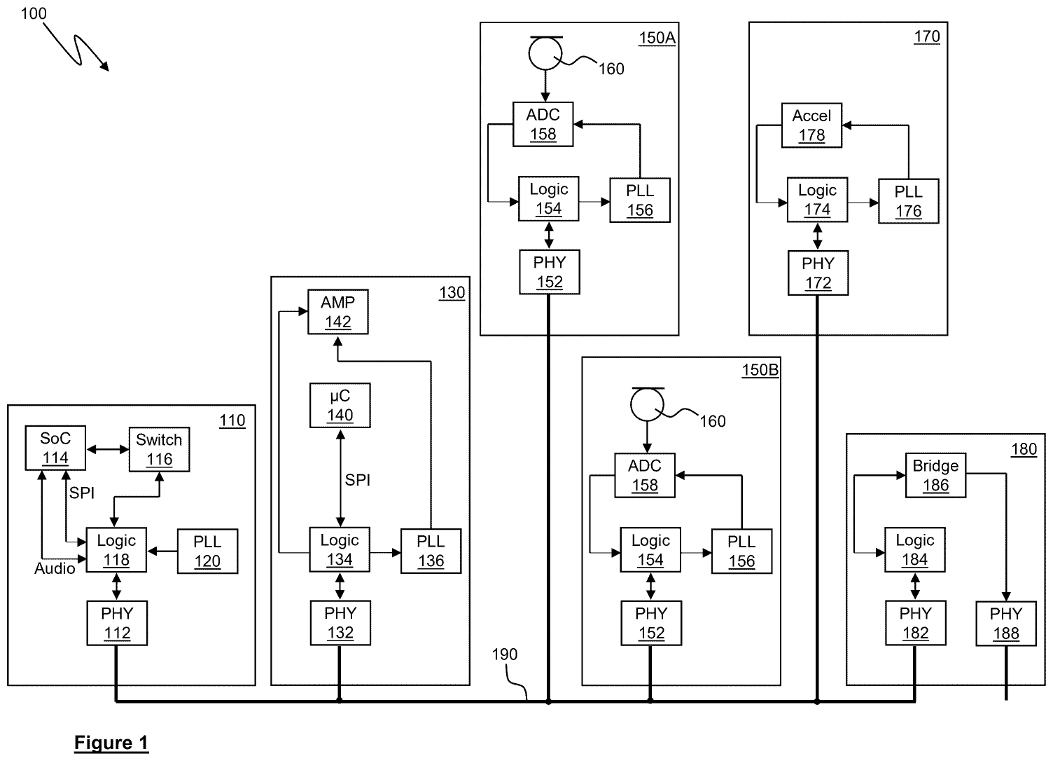

FIG. 1 is a schematic representation of an example multi-drop communications network in which the system and method of the present disclosure may be implemented.

The example multi-drop communications network, shown generally at 100 in FIG. 1, is a single-pair 10 Mbit/s multi-drop network that carries primary data and secondary data. The primary data is of a higher priority than the secondary data. It is to be appreciated that the examples described herein use a 10 Mbit/s network, but the principles of the present disclosure are equally applicable to networks that operate at different data rates. For example, the inventors envision that the principles of the present disclosure could equally be applied in networks that operate at data rates of 100 Mbit/s or even higher.

In the example of FIG. 1, the primary data comprises audio data, e.g. RNC audio data, having a first latency requirement, and the secondary data comprises 10Base-T1S Ethernet data having a second latency requirement that is less stringent than the first latency requirement. For example the primary data may be required to have a latency in the region of 100-200 μs, whereas the secondary data may only be required to have a latency in the region of 1-3 ms.

The example multi-drop communications network 100 comprises a network parent node 110 (which may also be referred to as a first node or as node 0), which in this example comprises an in-vehicle infotainment electronic control unit (IVI ECU).

The multi-drop communications network 100 further comprises a plurality of network child nodes, which in this example comprise an amplifier node 130 (which may be referred to as a second node or node 1), a first microphone node 150A (which may be referred to as a third node or node 2), a second microphone node 150B (which may be referred to as a fourth node or node 3), an accelerometer node 170 (which may be referred to as a fifth node or node 4) and a bridge node 180 (which may be referred to as a sixth node or node 5).

The parent node 110 and each of the plurality of child nodes 130-180 are coupled to a network bus 190, which may comprise, for example, a network cable such as a single twisted pair cable. The network bus 190 may be, for example, a 10 Mbit/s Ethernet bus. The network bus 190 is configured to carry data, and may also be configured to transmit power to one or more of the child nodes 130-180.

The parent node 110 and the plurality of child nodes 130-180 are coupled to the network bus 190 in a multi-drop configuration. In such a multi-drop configuration, transmission of data is inherently half-duplex. All the nodes 110-180 may receive any data transmitted to the network bus 190 by any node 110-180. Advantages of using such a multi-drop configuration include: lower cable costs, as multiple devices in a single zone (e.g. a single zone of a vehicle) can be coupled to a single wireform comprising multiple connectors crimped onto (or otherwise electrically connected to) a single twisted pair cable; lower connector costs, both on the nodes of the network and on the wireform; only one physical layer (PHY) interface is required per node, rather than two; only one set of electromagnetic compatibility (EMC) and power coupling filters is required, rather than two; support for a daisy-chain physical topology without incurring per-node forwarding latency.

The parent node 110 comprises a PHY interface 112 for coupling the parent node 110 to the network bus 190. The PHY interface 112 may be, for example, a 10 Mbit/s PHY interface. Similarly, each of the child nodes 130-180 comprises a respective PHY interface 132, 152, 172, 182 for coupling that child node to the network bus 190.

The parent node 110 further includes a system on a chip (SoC) 114, an Ethernet switch 116, protocol logic 118 and a phase-locked loop (PLL) 120.

The SoC 114 is configured to receive digital audio data indicative of detected road noise transmitted by the first and second microphone nodes 150A, 150B and digital accelerometer data transmitted by the accelerometer node 170 and to generate digital road noise cancellation audio signals based on the digital audio data and the digital accelerometer data, which are transmitted by the parent node 110 to the amplifier node 130 over the network bus 190.

The Ethernet switch 116 is operative to direct secondary data between the SoC 114 and the protocol logic 118. The protocol logic 118 is operative to encapsulate audio data into data microframes suitable for transmission on the network bus via the PHY interface 112, and to de-encapsulate received data microframes to extract audio data. The protocol logic 118 is further operative to encapsulate any Ethernet data (e.g. control data) received from the Ethernet switch 116 into Ethernet packets suitable for transmission on the network bus 190 via the PHY interface 112, and to de-encapsulate received Ethernet frames to extract Ethernet data for use by the SoC 114, in a manner that will be familiar to those of ordinary skill in the relevant art. The PLL 120 provides a clock reference signal for the audio data.

The amplifier node 130 is configured to receive the digital road noise cancellation audio signals transmitted by the parent node 110. Based on the received digital road noise cancellation audio signals, the amplifier node 130 is operative to generate and output road noise cancellation audio signals to one or more internal speakers of a host vehicle that incorporates the multi-drop communications network 100, so as to reduce an occupant of the host vehicle's perception of road noise.

To this end, the amplifier node 130 includes protocol logic 134, a PLL 136, a microcontroller 140, and amplifier circuitry 142. The protocol logic 134 is operative to de-encapsulate received data microframes to extract audio data. The PLL 136 is configured to provide a clock reference signal for the amplifier circuitry 142. The PLL 136 is also configured to receive a signal from the protocol logic 134, to synchronise a phase and frequency of its output. The signal received by the PLL 136 from the protocol logic 134 is derived from a signal received by the amplifier node 130 via the bus 190, e.g. a TDM or data cycle beacon of the kind described below. The microcontroller 140 is coupled to the protocol logic 134 by a bidirectional serial peripheral interface (SPI), such that the microcontroller 140 is able to transmit and receive secondary data for configuration and status purposes via the SPI interface.

The first and second microphone nodes 150A, 150B each include protocol logic 154, a PLL 156, an analog to digital converter (ADC) 158 and a microphone 160. The microphone 160 is operative to generate an analog audio output signal indicative, in this example, of road noise. The ADC 158 is operative to convert the analog audio output signal generated by the microphone 160 into a digital audio signal. This digital audio signal is output to the protocol logic 154, which is operative to encapsulate the digital audio signal into primary data microframes suitable for transmission on the network bus 190 via the PHY interface 152 of the microphone node 150A, 150B. The PLL 156 is configured to provide a clock reference signal for the ADC 158. The PLL 156 is also configured to receive a signal from the protocol logic 154, to synchronise a phase and frequency of its output. The signal received by the PLL 156 from the protocol logic 134 is derived from a signal received by the respective microphone node 150A, 150B via the bus 190, e.g. a TDM or data cycle beacon of the kind described below.

The accelerometer node 170 includes protocol logic 174, a PLL 176, and an accelerometer 178. The accelerometer 178 generates and outputs a digital accelerometer output signal to the protocol logic 174, which is operative to encapsulate the digital accelerometer output signal into primary data microframes suitable for transmission on the network bus 190 via the PHY interface 172 of the accelerometer node 170. The PLL 176 is configured to provide a clock reference signal for the accelerometer 178. The PLL 176 is also configured to receive a signal from the protocol logic 174, to synchronise a phase and frequency of its output. The signal received by the PLL 176 from the protocol logic 174 is derived from a signal received by the accelerometer node 170 via the bus 190, e.g. a TDM or data cycle beacon of the kind described below.

The bridge node 180 includes protocol logic 184, an Ethernet bridge 186, and a second PHY interface 188. The second PHY interface 188 may be, for example, a 10Base-T1S PHY interface for bridging secondary Ethernet data received over the network bus 190 to other local Ethernet devices.

The method and system of the present disclosure will be described with reference to the example multi-drop communications network 100 of FIG. 1, but it will be appreciated by those of ordinary skill in the art that the method and system of the present disclosure are equally suitable for use in other applications in which transmission of primary and secondary data in a communications network is necessary or desirable.

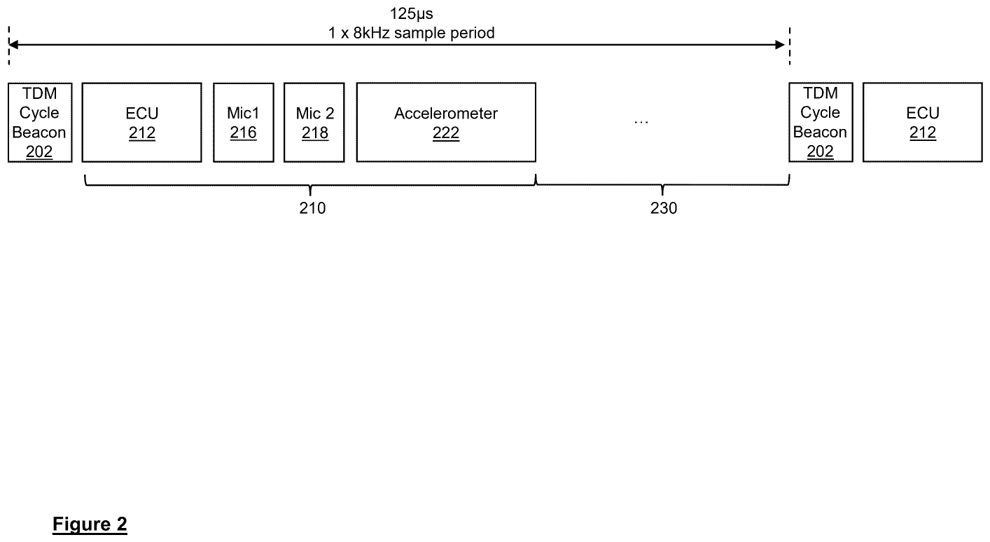

FIG. 2 is a schematic representation of a beacon-based transmission scheme used for transmission of primary data and secondary data in the example multi-drop communications network 100 of FIG. 1. In the example of FIG. 1, the primary data comprises low-latency audio and accelerometer data and the secondary data comprises Ethernet data, e.g. Ethernet control data.

In the transmission scheme illustrated in FIG. 2, the parent node 110 is operative to periodically broadcast or transmit a first beacon signal 202, also referred to as a time division multiplex (TDM) cycle beacon, to the network bus 190. In the example multi-drop communications network 100 of FIG. 1 the TDM cycle beacon 202 is transmitted by the parent node 110 once per audio sample period. For example, if a sample rate of 8 kHz is used for audio signals in the network 100, the TDM cycle beacon 202 is transmitted once every 125 μs. More generally, a TDM cycle beacon 202 is transmitted by the parent node 110 once per TDM beacon period, such that in the example of FIG. 1 a TDM beacon period is equal to the duration of an audio sample period, i.e. 125 μs.

The TDM cycle beacon 202 signals or defines the start of a primary data transmission interval 210. The primary data transmission interval 210 is a reserved slot (in time) for transmission of primary data (e.g. audio samples) by the nodes 110-180 to the network bus 190.

In the example network 100 of FIG. 1, each node 110-180 has a preconfigured number of transmit channels for transmitting primary data to the network bus 190.

For example, the parent node 110 may have first and second ECU transmit channels each comprising audio data samples. These ECU transmit channels are transmitted to the network bus 190 in an ECU data microframe 212. The first and second microphone nodes 150A, 150B may each have a respective single audio transmit channel of audio data samples, and these microphone transmit channels are transmitted to the network bus 190 in respective first and second microphone data microframes 216, 218. The accelerometer node 170 may have first, second and third transmit channels of accelerometer data samples, and these accelerometer transmit channels are transmitted to the network bus 190 in an accelerometer data microframe 222. In this example the amplifier node 130 and the bridge node 180 do not have any transmit channels, as they do not transmit primary data to the network bus 190.

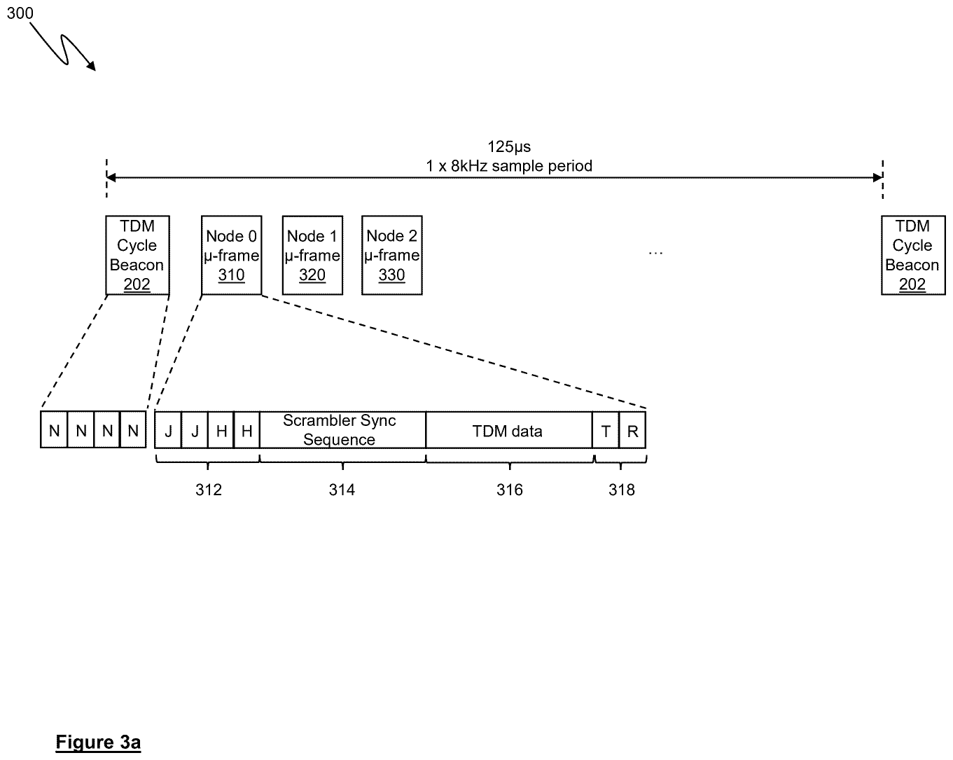

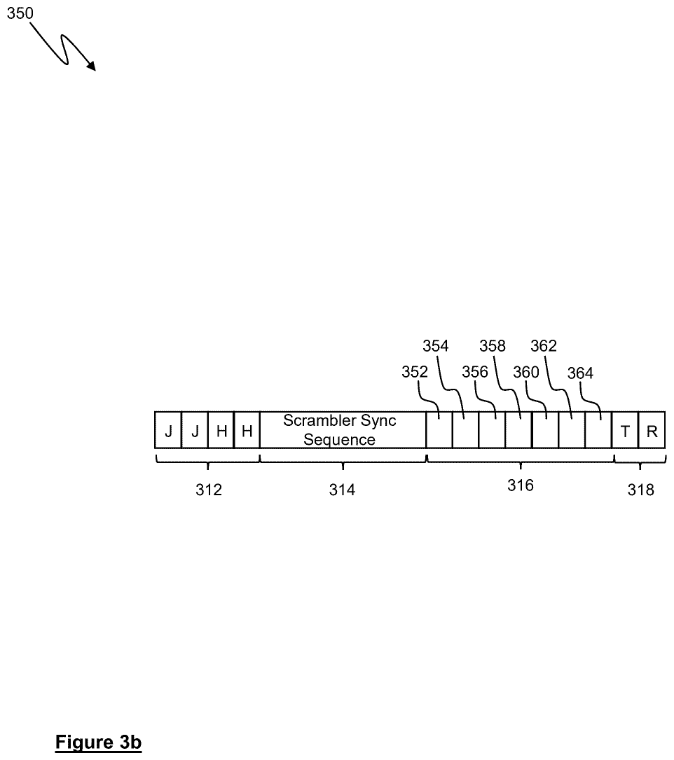

During the primary data transmission interval 210, the parent node 110 and each of the child nodes 130-180 transmit data samples of their transmit channels for the current sample period to the network bus 190 in a predefined primary data transmission order. In the example shown in FIG. 2 the predefined primary data transmission order is: parent node 110, first microphone node 150A, second microphone node 150B, accelerometer node 170. The transmit channels of each node 110-180 that has data samples to transmit are transmitted in respective data microframes, the structure of which is explained below with reference to FIG. 3a.

Thus, in the example shown in FIG. 2, immediately after transmission of the TDM beacon 202, the parent node 110 transmits the data samples of its first and second ECU transmit channels for the current audio sample period to the network bus 190 during the primary data transmission interval 210. The data samples of the first and second ECU transmit channels 212, 214 are transmitted in the ECU data microframe 212.

Following transmission of the ECU data microframe 212 containing the data samples of the first and second ECU transmit channels, the first microphone node 150A transmits the first microphone data microframe 216 containing a data sample of its audio transmit channel for the current audio sample period to the network bus 190.

The second microphone node 150B then transmits the second microphone data microframe 218 containing a data sample of its audio transmit channel for the current audio sample period to the network bus 190.

The accelerometer node 170 then transmits the accelerometer data microframe 222 containing the data samples of its first, second and third transmit channels for the current audio sample period to the network bus 190.

The provision of the primary data transmission interval 210 immediately following the TDM cycle beacon 202 ensures that every node's data samples for the current audio sample period are transmitted to the network bus 190 in a single TDM beacon period. The transmitted data samples can thus be received by every node 110-190 coupled to the network bus 190 in the same single TDM beacon period. This ensures that the network bus 190 transfers the data samples with a latency no greater than one audio sample period.

FIG. 3a is a schematic diagram showing an example structure of the TDM cycle beacon 202 and the data microframes containing the data samples of the nodes 110-180.

In the example shown generally at 300 in FIG. 3a, a TDM cycle beacon 202 is followed by a sequence of primary data microframes comprising a first primary data microframe 310 transmitted by the parent node (node 0) 110, a second primary data microframe 320 transmitted by a first child node (node 1) and a third primary data microframe 330 transmitted by a second child node (node 2).

The TDM cycle beacon 202 comprises a first particular combination of four symbols of the 5-bit symbol alphabet used in the Physical Coding Sublayer (PCS) in 10Base-T1S Ethernet (as defined by the IEEE Std 802.3cg-2019 standard). The use in the TDM cycle beacon 202 of the same signalling as in 10Base-T1S Ethernet provides for good electromagnetic compatibility (EMC) and signal integrity. The first particular combination of symbols used in the TDM cycle beacon 202 signals the start of a primary data transmission interval for transmission of primary data to other nodes coupled to the network bus 190. In order for the TDM cycle beacon 202 to unambiguously signal the start of the primary data transmission interval to the other nodes on the network bus 190, it is preferable for the first particular combination of symbols used in the TDM cycle beacon 202 to be highly discriminable in the presence of noise and bandwidth limiting when encoded with Differential Manchester Encoding (DME) as used in the 10Base-T1S PCS. In the example shown in FIG. 3a, the symbol combination “NNNN” is used as the first particular combination of symbols, as this combination is highly discriminable from other symbol combinations that are in use in the protocol described herein, but it will be appreciated by those of ordinary skill in the art that other symbol combinations that are not otherwise used in the protocol described herein, or are used in different contexts in the protocol described herein, may also be suitable.

Each primary data microframe 310, 320, 330 comprises a header 312, which is followed by a five-symbol scrambler synchronisation sequence 314. The scrambler synchronisation sequence 314 is in turn followed by the data samples 316 transmitted by the node, which are in turn followed by an end-of-frame delimiter 318. The data samples 316 in each primary data microframe 310, 320, 330 are scrambled, and the scrambler synchronisation sequence 314 can be used by a receiving node (i.e. a node 110-180 that receives the primary data microframe) to de-scramble the data samples 316.

The header 312 in this example comprises a second particular combination of four symbols of the 5-bit symbol alphabet used in the Physical Coding Sublayer (PCS) in 10Base-T1S Ethernet (as defined by the IEEE Std 802.3cg-2019 standard). As with the TDM cycle beacon 202, it is preferable that the second particular symbol combination of the header 312 is highly discriminable in the presence of noise and bandwidth limiting when encoded with DME, to distinguish the primary data microframe from a normal Ethernet frame. In the example shown in FIG. 3a, the symbol combination “JJHH” is used as the second particular combination of symbols in the microframe header 312, as this combination is highly discriminable from other symbol combinations that are in use in the protocol described herein, but it will be appreciated by those of ordinary skill in the art that other symbol combinations that are not otherwise used in the protocol described herein, or that are used in different contexts in in the protocol described herein, may also be suitable.

The end-of-frame delimiter 318 in this example comprises two symbols (here, T and R) that signal the end of the primary data microframe to other nodes (i.e. nodes other than the transmitting node) on the network bus 190.

In some examples the data samples 316 in a primary data microframe 310, 320, 330 all have the same sample rate, i.e. the source(s) from which the data samples were derived were sampled at a single sample rate, such that the primary data microframe 310, 320, 330 constitutes a single-rate primary data microframe. For example, the data samples 316 of a primary data microframe 310, 320, 330 may all be samples of audio streams that were sampled at a sample rate of 8 kHz.

In other examples, a primary data microframe 310, 320, 330 may be a multi-rate primary data frame in which one or more sources were sampled at two or more different sample rates. For example, the data samples of a primary data microframe 310, 320, 330 may comprise one or more samples of a first audio stream sampled a first sample rate of 8 kHz and one or more samples of the first audio data stream sampled at a second sample rate of 48 KHz. Alternatively, the samples at the second sampling rate may be samples of a second audio stream sampled at a different sampling rate than the first audio data stream, e.g. an 8 kHz sampling rate for the first audio data stream and a 48 KHz sampling rate for the second audio stream. In such examples the primary data microframe is transmitted at a TDM cycle rate that corresponds to the lower of the two sampling rates, e.g. 8 kHz.

FIG. 3b illustrates such a multi-rate primary data microframe. As shown generally at 350 in FIG. 3b, a multi-rate microframe comprises a header 312 and a five-symbol scrambler synchronisation sequence 314 of the kind described above with reference to FIG. 3a. The scrambler synchronisation sequence 314 is followed by multi-rate TDM data, which in this example comprises a first audio sample 352 sampled at a sample rate of 8 kHz and second to seventh audio samples 354-364 sampled at a sample rate of 48 kHz. In this example the primary data microframe 350 will be transmitted at a TDM cycle rate of 8 kHz, as this corresponds to the lower of the two sample rates of the samples 352-364.

A minimum inter-microframe gap or delay (i.e. a period of time between adjacent primary data microframes and between the end of the TDM cycle beacon 202 and the first primary data microframe) may be implemented by the parent node 110 and the child nodes 130-180 in the network 100, to prevent primary data microframe transmissions from different nodes from overlapping due to propagation delays, e.g. in the network bus 190, and/or to prevent signal decoding errors between primary data microframes. For example, a minimum gap or delay of 0.5 microseconds may be implemented between the TDM cycle beacon 202 and the first primary data microframe, and between adjacent primary data microframes.

Although the data samples 316 in each primary data microframe 310, 320, 330 are scrambled, the transmission pattern of TDM cycle beacons 202 and primary data microframes 310, 320, 330 repeats at the TDM cycle beacon rate, which in the example shown in FIG. 3a is 8 kHz (but which may be a different rate, e.g. between 4 kHz and 48 KHz depending on the application in which the beacon-based transmission scheme is being used), and the primary data microframe transmission pattern (comprising the header 312, scrambler synchronisation sequence 314, data samples 316 and end-of-frame delimiter) recurs periodically a number of times within the TDM cycle. This may lead to strong periodicity at frequencies a few times higher than the TDM cycle beacon rate, which could cause strongly tonal signal harmonics at frequencies in the low hundreds of KHz. Such harmonics may be problematic in applications that use frequencies in the AM (amplitude modulation) band (e.g. in the frequency range 535 kHz-1605 kHz). Such applications may include, for example, automotive applications in vehicles that have AM radio receivers, or automotive applications where key fobs used for remotely controlling locking, unlocking and/or other functions of a vehicle use AM frequencies.

To mitigate this, approaches that may break up tonal content, particularly in the AM band, may be used.

In one approach, the transmission timing of the TDM cycle beacon 202 is randomly (or pseudo-randomly) delayed from its nominal position by a number of symbol periods, e.g. a maximum of 15 symbol periods, according to a suitable random (or pseudo-random) distribution function such as a random probability density function (RPDF) or a triangular probability density function (TPDF) with a variable amplitude. This has the effect of breaking the periodicity of the transmission of TDM cycle beacons 202, thus reducing tonal content arising from the periodic transmission of TDM cycle beacons 202.

A randomisation value indicative of the number of symbol periods by which the TDM cycle beacon is delayed is indicated in a symbol appended to (or otherwise associated with) the TDM cycle beacon. Receiving nodes use the randomisation value to compensate timing in phase locked loop (PLL) reference clock generation. For example, the randomisation value may be loaded into a 4-bit counter which increments at the symbol rate, and when the counter rolls over to zero, the PLL reference clock generation is asserted. In this way, the frequency and phase of the PLL reference clock generation is consistent even though the transmission timing of the TDM cycle beacon is randomised.

In another approach, each node 110-180 may delay the transmission of a primary data microframe by a randomised (or pseudo-randomised) number of symbol periods with a variable amplitude, according to a suitable random (or pseudo-random) distribution function such as a random probability density function (RPDF) or a triangular probability density function (TPDF) with a variable amplitude. This has the effect of breaking the periodicity of the transmission of primary data microframes, thus reducing tonal content arising from the periodic transmission of primary data microframes. The minimum inter-microframe gap or delay is maintained in this approach, such that the random (or pseudo-random) delay is in addition to the inter-microframe gap or delay.

The channel configuration for the network 100 is static but configurable, in the sense that the configuration of the network 100 cannot be changed while the network is in operation, but if all the nodes 110-180 are disabled, reconfigured and then re-enabled, the configuration of the network 100 can be changed to accommodate a different number of nodes (e.g. if one or more new nodes are added to the network 100) or a different channel configuration for an existing node.

Each node 110-180 in the network 100 may be provided with network configuration information indicative of the number of transmit channels of each node and the predefined primary data transmission order.

Each node 110-180 is operative to determine the correct point within the primary data transmission interval 210 at which to transmit its primary data microframe using the network configuration information. For example, each node 110-180 may be operative to determine, based on the position of that node in the predefined primary data transmission order and the number of transmit channels of each of the preceding nodes in the predefined primary data transmission order, a byte or time offset from the TDM cycle beacon representing the point within the primary data transmission interval 210 at which that node should transmit its primary data microframe to the network bus 190.

In other examples, each node 110-180 may count the number of demarcated transmissions on the network bus 190 that have occurred since the transmission of the TDM cycle beacon 202 to determine the correct point within the primary data transmission interval 210 at which to transmit its primary data microframe. For example, each node may count the number of end-of-frame delimiters 318 that have been transmitted to the network bus 190 since the TDM cycle beacon 202, and compare the resulting value to its own position in the predefined primary data transmission order to determine the point within the primary data transmission interval 210 at which that node should transmit its primary data microframe to the network bus 190.

Referring again to FIG. 2, after all the nodes 110-180 have transmitted their primary data microframes to the network bus 190, any available bus time (i.e. time when no data is being transmitted to the network bus 190) before the next TDM cycle bacon 202 is transmitted to the network bus 190 can be used to provide a secondary data transmission interval 230 during which secondary data such as Ethernet data may be transmitted to the network bus 190 by the nodes 110-180 in a predefined secondary data transmission order.

To this end, the parent node 110 is further operative to broadcast or transmit a second beacon signal (also referred to as a data cycle beacon) to the network bus 190, in place of the TDM cycle beacon 202, to signal the start of a secondary data frame in which each node 110-180 has an opportunity to transmit a frame of secondary data to the network bus 190.

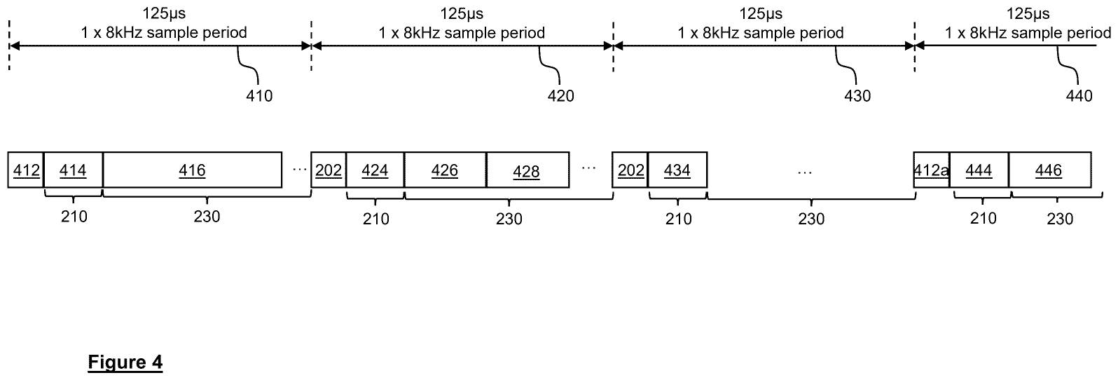

FIG. 4 is a schematic representation of the beacon-based transmission scheme of FIG. 2, showing transmission of secondary data (e.g. Ethernet data) as well as primary data (e.g. audio data).

In the example shown in FIG. 4, a second beacon signal 412, also referred to as a data cycle beacon, is transmitted by the parent node 110 to the network bus 190, in place of the TDM cycle beacon 202. FIG. 4 shows a sequence of first to fourth consecutive TDM beacon periods 410, 420, 430, 440, in which a data cycle beacon 412 is transmitted at the beginning of the first TDM beacon period 410 and at the beginning of the fourth TDM beacon period 440, and a TDM cycle beacon 202 is transmitted at the beginning of each of the second and third TDM beacon periods 420, 430.

The data cycle beacon 412 comprises a third particular combination of symbols of the 5-bit symbol alphabet used in the Physical Coding Sublayer (PCS) in 10Base-T1S Ethernet (as defined by the IEEE Std 802.3cg-2019 standard). The third particular combination of symbols is different from the first particular combination of signals used in the TDM cycle beacon 202, to allow receiving nodes to distinguish the data cycle beacon 412 from the TDM cycle beacon 202.

The data cycle beacon 412 serves two functions.

Its first function is the same as that of the TDM cycle beacon 202, to signal or define the beginning of the primary data transmission interval 210 for transmission of primary data to the network bus 190.

The second function of the data cycle beacon 412 is to signal, define or initiate a secondary data frame cycle in which each node 110-180 has an opportunity (also referred to as a frame transmission opportunity) to transmit one frame of secondary data to the network bus 190. The frame of secondary data transmitted to the network bus 190 by a node 110-180 in a frame transmission opportunity may be an Ethernet data frame. The frame transmission opportunities are provided to the nodes in a predefined secondary data transmission order.

The data cycle beacon 412 may comprise the symbol combination NNNNHRJN, for example. It will be noted that in this example the first four symbols of the data cycle beacon are the same as the symbols of the TDM cycle beacon 202 described above with reference to FIG. 3a. The use of the same symbol combination in the TDM cycle beacon 202 and the beginning of the data cycle beacon 412 helps to ensure that the data cycle beacon 412 is recognised by the child nodes 130-180 of the network 100 as signalling the start of a TDM beacon period as well as the start of a secondary data frame cycle.

The secondary data frame cycle operates in a similar manner to a physical layer collision avoidance (PLCA) scheme used in 10Base-T1S Ethernet to ensure that within each data cycle beacon period, each node 110-180 has an opportunity to transmit one frame of secondary data following the transmission, by all the nodes 110-180 (that have primary data to transmit), of their primary data microframes to the network bus 190.

Thus, in the example shown in FIG. 4, during the first TDM beacon period 410, the data cycle beacon 412 is transmitted to signal both the beginning of the primary data transmission interval 210 and to initiate a secondary data frame cycle. Immediately after the data cycle beacon 412 has been transmitted, the nodes 110-180 transmit their primary data microframes 414 for the first TDM beacon period 410 to the network bus 190, in the predefined primary data transmission order, during the primary data transmission interval 210, as described above with reference to FIG. 2. It will thus be understood that block 414 of FIG. 4 represents all the primary data microframes transmitted by the nodes 110-180 in the primary data transmission interval 210 for the TDM beacon period 410.

Once the primary data microframes 414 of all the nodes 110-180 that have primary data to transmit have been transmitted in the primary data transmission interval 210 of the first TDM beacon period 410, one or more secondary data frames (e.g. Ethernet frames) can be transmitted by the nodes 110-180 in the predefined secondary data transmission order in a secondary data transmission interval 230 between the end of the primary data transmission interval 210 and the transmission of the TDM cycle beacon 202 for the second TDM beacon period 420.

In example shown in FIG. 4, three of the nodes (e.g. the parent node 110 (node 0), the amplifier node 130 (node 1) and the first microphone node 150A (node 2)) each have a secondary data frame to transmit. Thus, secondary data frames 416, 426, 428 are transmitted by the nodes that have secondary data frames to transmit during the secondary data frame cycle that follows transmission of the data cycle beacon 412.

During the secondary data transmission interval 230 for the first TDM beacon period 410, the first of the nodes that has secondary data to transmit (e.g. the parent node 110) transmits its secondary data frame 416 to the network bus 190. After the secondary data frame 416 has been transmitted, the network bus 190 remains inactive until the beginning of the second TDM beacon period 420.

A TDM cycle beacon 202 is transmitted by the parent node 110 at the beginning of the second TDM beacon period 420. Immediately after the TDM cycle beacon 202 has been transmitted, the nodes 110-180 transmit their primary data microframes 424 for the second TDM beacon period 420 to the network bus 190, in the predefined primary data transmission order, during the primary data transmission interval 210, as described above with reference to FIG. 2.

Once the primary data microframes 424 of all the nodes 110-180 have been transmitted in the primary data transmission interval 210 of the second TDM beacon period 420, secondary data frames (e.g. Ethernet frames) 426, 428 are transmitted by the second and third nodes (e.g. the amplifier node 130 and the first microphone node 150A) that have secondary data to transmit in a secondary data transmission interval 230 between the end of the primary data transmission interval 210 and the transmission of the TDM cycle beacon 202 for the third TDM beacon period 430.

After the secondary data frames 426, 428 have been transmitted, the network bus 190 remains inactive until the beginning of the third TDM beacon period 430.

A TDM cycle beacon 202 is transmitted by the parent node 110 at the beginning of the third TDM beacon period 430. Immediately after the TDM cycle beacon 202 has been transmitted, the nodes 110-180 transmit their primary data microframes 434 for the third TDM beacon period 420 to the network bus 190, in the predefined primary data transmission order, during the primary data transmission interval 210, as described above with reference to FIG. 2.

Again, once the primary data microframes 434 of all the nodes 110-180 have been transmitted in the primary data transmission interval 210 of the third TDM beacon period 430, an opportunity exists for the nodes 110-180 to transmit secondary data frames in a secondary data transmission interval 230 after the end of the primary transmission interval 210 and the start of the fourth TDM beacon period 440.

In this example, the nodes that had secondary data to transmit have transmitted their secondary data frames during the secondary data transmission intervals 230 of the first and second TDM beacon intervals 410, 420, and those nodes that did not have secondary data to transmit have had an opportunity to transmit secondary data during the secondary data transmission intervals of the second and third TDM beacon intervals 420, 430.

As all the nodes of the network 100 have had an opportunity to transmit a secondary data frame within the secondary data frame cycle signalled by the data cycle beacon 412 that was transmitted at the beginning of the first TDM beacon interval 410, instead of transmitting a TDM cycle beacon 202 at the beginning of the fourth TDM beacon interval 440, the parent node 110 transmits a further data cycle beacon 412a to signal both the start of the fourth TDM beacon interval 440 and the start of a new secondary data frame cycle.

Immediately after this new data cycle beacon 412a has been transmitted, the nodes 110-180 transmit their primary data microframes 444 for the fourth TDM beacon period 440 to the network bus 190, in the predefined primary data transmission order, during the primary data transmission interval 210, as described above with reference to FIG. 2.

Again, once the primary data microframes 444 of all the nodes 110-180 have been transmitted in the primary data transmission interval 210 of the fourth TDM beacon period 440, an opportunity exists for the nodes 110-180 to transmit secondary data frames in a secondary data transmission interval 230 between the end of the primary transmission interval 210 and the beginning of a fifth TDM beacon period (not shown in FIG. 4).

In this example, the first node in the predetermined secondary data transmission order that has a secondary data frame to transmit (e.g. the parent node 110) transmits a secondary data frame 446 during the secondary data transmission interval 230 for the fourth TDM beacon period 440. The other nodes in the network 100 each have an opportunity to transmit a secondary data frame. The parent node 110 will again transmit a data cycle beacon 412 instead of a TDM cycle beacon 202 at the beginning of the next TDM beacon period after all the nodes have either transmitted their secondary data frames (if they have secondary data to transmit) or allowed their opportunity to transmit a secondary data frame to pass without transmitting a secondary data frame (if they have no secondary data to transmit).

The parent node 110 and the child nodes 130-180 may be configured to implement a random or pseudo-random delay to the transmission timing of their respective secondary data frames, in a similar manner to the random or pseudo-random delay to the TDM cycle beacon 202 introduced by the parent node 110 and/or the random or pseudo-random delay to primary data microframes introduced by the nodes 110-180, to reduce tonal content that may arise as a result of periodic transmission of secondary data frames.

In some circumstances, a secondary data frame transmitted by one of the nodes 110-180 may exceed the available idle time of the network bus 190 following transmission of the primary data microframes of all the nodes 110-180 in a TDM beacon period, such that the complete secondary data frame cannot be transmitted to the network bus 190 before the next TDM cycle beacon 202 is transmitted. In such circumstances, the data frame may be split over two or more TDM beacon periods.

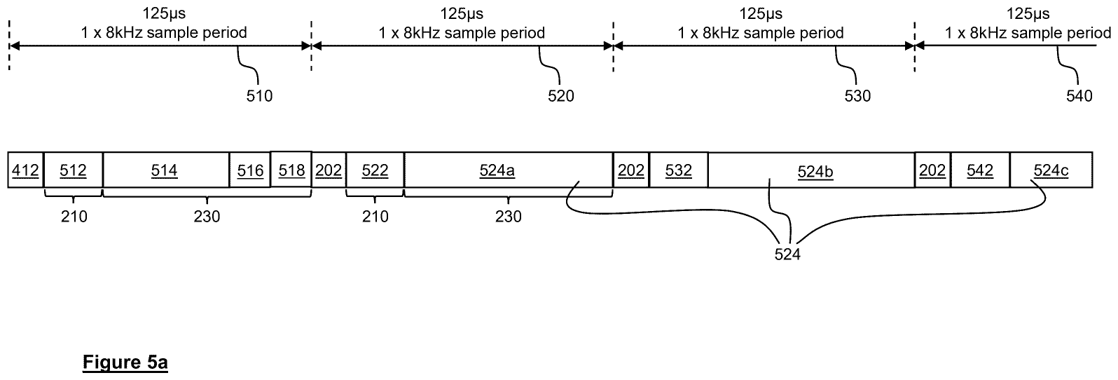

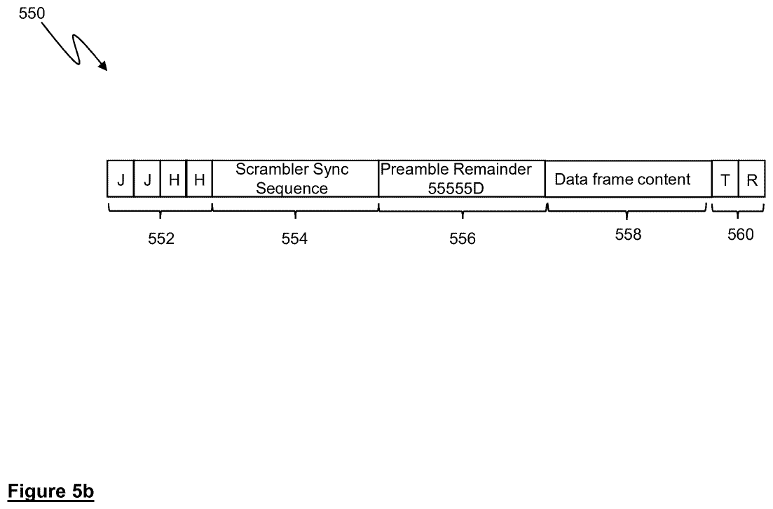

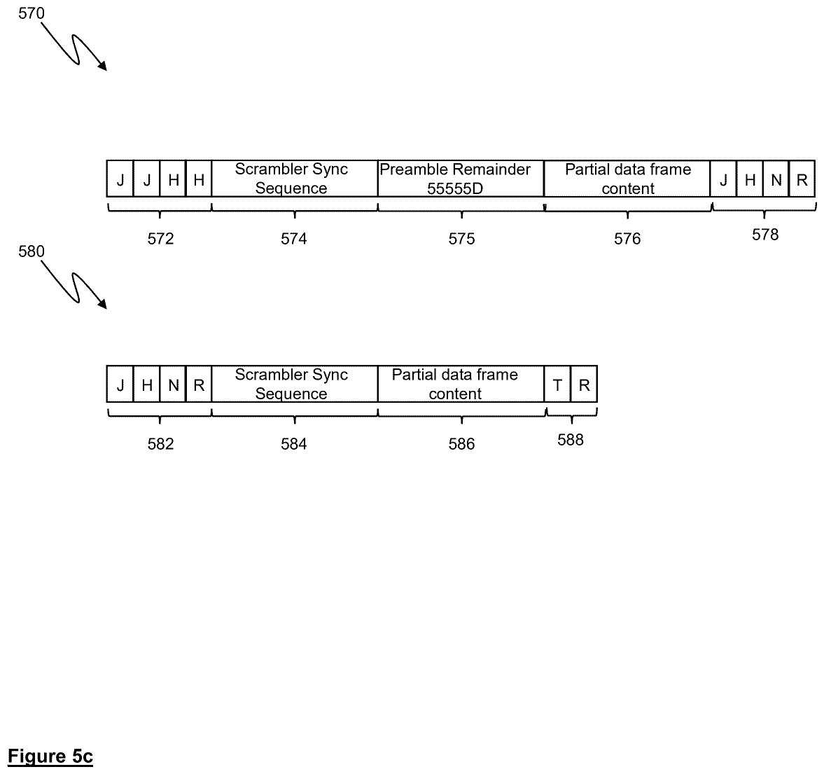

FIG. 5a is a schematic representation of the beacon-based transmission scheme of FIG. 2, showing transmission of secondary data (e.g. Ethernet data) as well as primary data (e.g. audio data), in which a frame of secondary data is split over a plurality of TDM beacon periods.

In the example shown in FIG. 5a, a data cycle beacon 412 is transmitted by the parent node 110 to the network bus 190, in place of the TDM cycle beacon 202, to signal the start of a secondary data frame cycle. FIG. 5a shows a sequence of first to fourth consecutive TDM beacon periods 510, 520, 530, 540, in which a data cycle beacon 412 is transmitted at the beginning of the first TDM beacon period 510 and a TDM cycle beacon 202 is transmitted at the beginning of each of the second to fourth TDM beacon periods 520-540.

Thus, in the example shown in FIG. 5a, during the first TDM beacon period 510, the data cycle beacon 412 is transmitted to signal both the beginning of the primary data transmission interval 210 and to signal or initiate a secondary data frame cycle. Immediately after the data cycle beacon 412 has been transmitted, the nodes 110-180 transmit their primary data microframes 512 for the first TDM beacon period to the network bus 190, in the predefined primary data transmission order, during the primary transmission interval 210, as described above with reference to FIG. 2. It will thus be understood that block 512 of FIG. 5a represents the primary data microframes transmitted by all the nodes 110-180 in the primary data transmission interval 210 for the first TDM beacon period 510.

Once the primary data microframes 512 of all the nodes 110-180 have been transmitted in the primary transmission interval 210 of the first TDM beacon period 510, each node 110-180 is given an opportunity to transmit one secondary data frame. Secondary data frames (e.g. Ethernet frames) are transmitted by the nodes 110-180 in the predefined secondary data transmission order in the secondary data transmission interval 230.

In this example, the parent node 110 (node 0) and the second microphone node 150B (node 3) each have secondary data frames to transmit, whereas the amplifier node 130 (node 1) and the first microphone node 150A (node 2) have no secondary data frames to transmit.

During the secondary data transmission interval 230 of the first TDM beacon period 510, the parent node 110 transmits its data frame 514. In this example the amplifier node 130 and the first microphone node 150A each transmit a respective “Yield” signal 516, 518, indicating that they have no data frame to transmit, in the secondary data transmission interval 230 of the first TDM beacon period 510. The data frame 514 and the Yield signals 516, 518 in this example occupy all the available idle time of the network bus 190 in the first TDM beacon period 510.

A TDM cycle beacon 202 is transmitted by the parent node 110 at the beginning of the second TDM beacon period 520. Immediately after the TDM cycle beacon 202 has been transmitted, the nodes 110-180 transmit their primary data microframes 522 for the second TDM beacon period 520 to the network bus 190, in the predefined primary data transmission order, during the primary data transmission interval 210, as described above with reference to FIG. 2.

Once the primary data microframes 522 of all the nodes 110-180 have been transmitted in the primary data transmission interval 210 of the second TDM beacon period 520, the nodes 110-180 can continue to transmit secondary data frames in the predefined secondary data transmission order in the secondary data transmission interval 230 of the second TDM beacon period 520.

The second microphone node 150B (node 3) thus begins transmitting its secondary data frame 524 in the secondary data transmission interval 230 of the second TDM beacon period 520. However, in this example the secondary data frame of the second microphone node 150B is longer than the available idle time of the network bus 190 following transmission of the primary data microframes 522 of all the nodes 110-190 in the primary data transmission interval 210 for the second TDM beacon period 520, and therefore cannot be transmitted in its entirety in the secondary data transmission interval 230 of the second TDM beacon period 520. To permit transmission of the secondary data frame 524 in its entirety, the secondary data frame 524 is split into a plurality (in this example three) of portions 524a, 524b, 524c. Only a first portion 524a, of a length equal to (or shorter than) the available idle time of the network bus 190, is transmitted in the secondary data transmission interval 230 of the second TDM beacon period 520. The remaining portions 524b, 524c are transmitted in the subsequent third and fourth TDM beacon periods 530, 540.

A new TDM cycle beacon 202 is transmitted by the parent node 110 at the beginning of the third TDM beacon period 530. Immediately after this new TDM cycle beacon 202 has been transmitted, the nodes 110-180 transmit their primary data microframes 532 for the third TDM beacon period 530 to the network bus 190, in the predefined primary data transmission order, during the primary data transmission interval 210, as described above with reference to FIG. 2.

Once the primary data microframes 532 of all the nodes 110-180 have been transmitted in the primary data transmission interval 210 of the third audio sample period 530, the nodes 110-180 can continue to transmit secondary data frames in the predefined secondary data transmission order in the secondary data transmission interval 230 of the third TDM beacon period 530.

In this example, a second portion 524b of the secondary data frame 524 of the second microphone node 150B is transmitted in the secondary data transmission interval 230 of the third TDM beacon period 530. The second portion 524b is of a length equal to (or shorter than) the available idle time of the network bus 190 following the transmission of the primary data microframes 532 in the primary data transmission interval 210 of the third TDM beacon period 530.

In this example, the secondary data frame 524 of the second microphone node 150B is longer than the combined available idle time of the network bus 190 following transmission of the primary data microframes 522, 532 in the second and third TDM beacon periods 520, 530, and thus a third portion 524c of the secondary data frame 524 is transmitted in the secondary data transmission interval 230 of the fourth TDM beacon period 540, following transmission of a further TDM cycle beacon 202 and the primary data microframes 542 for the fourth TDM beacon period 540.

The transmitting node (i.e. a node 110-180 that will transmit a data frame in the current audio sample period) is operative to determine whether the secondary data frame is to be transmitted or not, and whether the secondary data frame is to be split over two or more audio sample periods in the manner described above.

If the secondary data frame to be transmitted is of a length that will fit entirely within the secondary data transmission interval 230 of a current TDM beacon period between the end of the primary data transmission interval 210 and the transmission of the TDM cycle beacon 202 or data cycle beacon 412 for the next audio sample period, the secondary data frame is transmitted by the transmitting node 110-180 in the same way as a 10Base-T1S/IEEE802.3cg-compliant Ethernet frame. The secondary data frame 514 transmitted by the parent node (node 0) in the example shown in FIG. 5a is transmitted in this way.

FIG. 5b illustrates the structure of a secondary data frame transmitted in this way. As shown in FIG. 5b, the secondary data frame 550 includes a preamble 552 comprising, in this example, the four-symbol combination JJHH, followed by a five symbol scrambler synchronisation sequence 554, followed by a preamble remainder 556 of value 55555D, followed by the secondary data content 558 of the secondary data frame 550, which may be between 64 and 1536 octets in length, followed by an end-of-frame delimiter 560, which in this example comprises the two-symbol combination TR.

In some examples, if the transmitting node 110-180 determines that the next TDM cycle beacon 202 or data cycle beacon 412 is expected to be transmitted within a predefined period, e.g. 15 symbol periods plus a predefined timing margin, it does not start transmitting its secondary data frame in the current TDM beacon period, as there may be insufficient time remaining in the current TDM beacon period to transmit at least one octet of the data frame.

If the transmitting node 110-180 has commenced transmission of a secondary data frame and determines that the next TDM cycle beacon 202 is expected to be transmitted within a predefined period, e.g. 6 symbol periods, it suspends transmission of the secondary data frame on an octet boundary and transmits a “Suspend” symbol combination (e.g. JHNR). After the end of the primary data transmission interval 210 of the next TDM beacon period, the transmitting node resumes transmission of the secondary data frame by transmitting a “Resume” symbol combination (e.g. JHNR) followed by a synchronisation sequence (which may comprise five symbols) and the remaining data of the secondary data frame. The secondary data frame 524 transmitted by the second microphone node 150B in the example shown in FIG. 5a is transmitted in this way, with “Suspend” symbol combinations being transmitted in the secondary data transmission intervals 220 of the second and third TDM beacon periods 520, 530 and “Resume” symbol combinations being transmitted at the start of the secondary data transmission intervals 220 of the third and fourth TDM beacon periods 530, 540.

FIG. 5c illustrates transmission of partial secondary data frames with suspend and resume symbol combinations.

In a first TDM beacon period, a first partial secondary data frame 570 is transmitted. The first partial secondary data frame includes a preamble 572 comprising, in this example, the four-symbol combination JJHH, followed by a five symbol scrambler synchronisation sequence 574, followed by a preamble remainder 575, followed by first partial secondary data frame content 576, which may be between 1 and 1535 octets in length, followed by a “Suspend” symbol combination, which in this example comprises the four-symbol combination JHNR.

In a second TDM beacon period, a second partial secondary data frame 580 is transmitted. The second partial secondary data frame 580 includes a “Resume” symbol combination 582, which in this example comprises the four-symbol combination JHNR, followed by a five symbol scrambler synchronisation sequence 584, followed by second partial secondary data frame content 586, which may be between 1 and 1535 octets in length, followed by an end of frame delimiter 588, which in this example comprises the two-symbol combination TR.

In the example described above with reference to FIG. 5a, a plurality of transmit opportunity windows are provided in which each node 110-180 can in turn (in the predefined secondary data transmission order) transmit either a secondary data frame or a Yield signal, if it has no data frame to transmit.

In an alternative approach, each node 110-180 include a transmit opportunity counter operative to count transmit opportunities since the transmission of the data cycle beacon 412, and uses the value of its transmit opportunity counter to determine when to transmit a secondary data frame in the secondary data transmission interval 230.

The transmit opportunity counter of each node 110-180 is initialised (e.g. reset to a predefined value such as zero) when a data cycle beacon 412 is transmitted by the parent node 110, and is incremented every time a node 110-180 transmits its secondary data frame to the network bus 190. A node 110-180 may determine a transmit opportunity window within the secondary data transmission interval 230 within which to transmit its secondary data frame based on a comparison of the value of the position of that node in the predefined secondary data transmission order and the value of the transmit opportunity counter. When the value of the transmit opportunity counter is equal to the position of a node 110-180 in the predefined secondary data transmission order, that node should transmit its secondary data frame in the current transmit opportunity window.

In this alternative approach, if a node has no secondary data frame to transmit in a transmit opportunity window, instead of transmitting a Yield signal, that node does not transmit any data in the relevant transmit opportunity window. If a transmit opportunity window elapses without the corresponding node 110-180 commencing transmission of a secondary data frame (as may be indicated, for example, by transmission by the relevant node 110-180 of a Commit or Sync symbol of a kind that will be familiar to those of ordinary skill in the art), the parent node 120 transmits a Transmit Opportunity Increment signal, which may be, for example, a predefined symbol combination, to the network bus 190. In response to the Transmit Opportunity Increment signal, each of the child nodes 130-180 increments its own transmit opportunity counter, such that the expiry of the transmit opportunity window is accounted for and the subsequent nodes in the predefined secondary data transmission order can each transmit their secondary data frames in the correct transmit opportunity window.

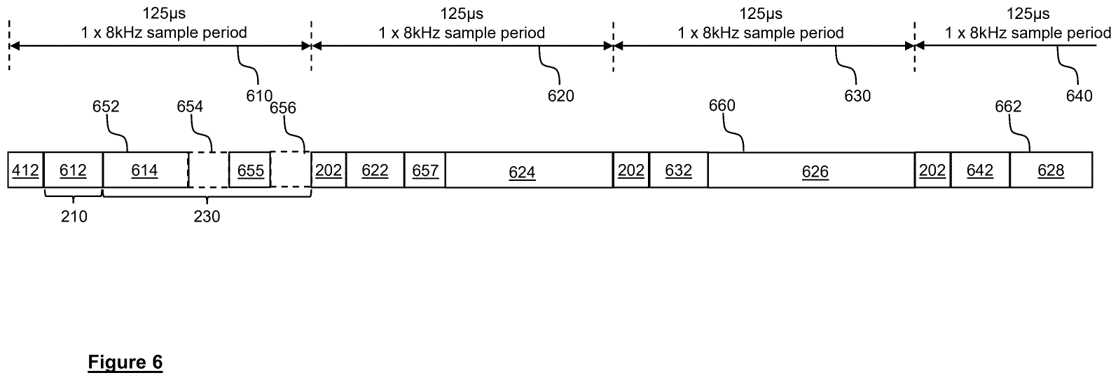

FIG. 6 is a schematic representation of an example of this alternative approach.

In the example illustrated in FIG. 6, the parent node 110, the second microphone node 150B, the accelerometer node 170 and the bridge node 180 each have a secondary data frame to transmit during a secondary data cycle, but the amplifier node 130 and the first microphone node 150A each have no secondary data frame to transmit during the secondary data cycle. For simplicity it is assumed in FIG. 6 that the secondary data frames of the parent node 110, the second microphone node 150B, the accelerometer node 170 and the bridge node 180 are each of a length that will fit entirely within the secondary data transmission interval 230 of a current TDM beacon period between the end of the primary data transmission interval 210 and the transmission of the TDM cycle beacon 202 for the next TDM beacon period, but it is to be appreciated that longer secondary data frames may be split between two or more TDM beacon periods in the manner described above with reference to FIG. 5a.

In the example illustrated in FIG. 6, the parent node 110 occupies position 0 in the predefined secondary data transmission order. The amplifier node 130, first microphone node 150A, second microphone node 150B and accelerometer node 170 occupy positions 1, 2, 3 and 4, respectively, in the predefined secondary data transmission order. A transmit opportunity counter of each node 110-180 is set to zero on transmission of a data cycle beacon 412 that signals the start of both a primary data transmission interval 210 and a secondary data cycle.

Thus, when the transmit opportunity counters of all the nodes 110-180 are at value 0 immediately after transmission of the data cycle beacon 412, the value of each transmission opportunity counter is equal to the value of the position of the parent node 110 in the predefined secondary data transmission order, and the parent node transmits its secondary data frame 614 during a current transmit opportunity window 652.

The transmission of the data frame 614 is detected by the nodes 110-180, which each increment their respective transmit opportunity counter in response, such that their value is now 1.

This transmit opportunity counter value corresponds to the value of the position of the amplifier node 130 in the predefined secondary data transmission order. However, the amplifier node 130 has no secondary data frame to transmit. Accordingly, instead of transmitting a Yield signal (as would occur in the example of FIG. 5a), the amplifier node 130 does not transmit any signal during the now-current transmit opportunity window 654.

The parent node 110 detects that the transmit opportunity window 654 has elapsed without a secondary data frame being transmitted, and thus transmits a Transmit Opportunity Increment signal 655 to the network bus 190. In response, each of the nodes 130-180 increments its transmit opportunity counter, such that the value of each transmit opportunity counter is 2.

This transmit opportunity counter value corresponds to the value of the position of the first microphone node 150A in the predefined secondary data transmission order. As noted above, the first microphone node 150A has no secondary data frame to transmit. Accordingly, instead of transmitting a Yield signal (as would occur in the example of FIG. 5a), the first microphone node 150A does not transmit any signal during the now-current transmit opportunity window 656.

Again, the parent node 110 detects that the transmit opportunity window 656 has elapsed without a secondary data frame being transmitted, and thus transmits a Transmit Opportunity Increment signal 657 to the network bus 190. In this example, because the transmit opportunity window 656 elapsed shortly before the transmission of the next TDM cycle beacon 202, the transmission of the Transmit Opportunity Increment signal 657 is delayed until the start of the next secondary data interval after the primary data microframes 622 have been transmitted by the nodes during the primary data interval 210 for the second TDM beacon period 620. In response to the Transmit Opportunity Increment signal 657, each of the nodes 130-180 again increments its transmit opportunity counter, such that the value of each transmit opportunity counter is now 3.

This transmit opportunity counter value corresponds to the value of the position of the second microphone node 150B in the predefined secondary data transmission order, so the second microphone node 150B transmits its secondary data frame 624 during the now-current transmit opportunity window 658.

The transmission of the secondary data frame 624 is detected by the nodes 110-180, which each increment their respective transmit opportunity counter in response, such that their value is now 4.

This transmit opportunity counter value corresponds to the value of the position of the accelerometer node 170 in the predefined secondary data transmission order, so the accelerometer node 170 transmits its secondary data frame 626 during the now-current transmit opportunity window 660.

Again, the transmission of the secondary data frame 626 is detected by the nodes 110-180, which each increment their respective transmit opportunity counter again in response, such that their value is now 5.

This transmit opportunity counter value corresponds to the value of the position of the bridge node 180 in the predefined secondary data transmission order, so the bridge node 180 transmits its secondary data frame 628 during the now-current transmit opportunity window 662.

Forcing the child nodes 130-180 to increment their transmit opportunity counters in this way ensures that the transmit opportunity counters of all the child nodes 130-180 are synchronised, which in turn improves the robustness and resilience of the network 100, in comparison to the Yield signal approach described above with reference to FIG. 5a.

In the event of failure of a node in the Yield signal approach of FIG. 5a, the failed node will not transmit any signal to the network bus in the relevant transmit opportunity window. This absence of any signal could cause the subsequent nodes in the predefined secondary transmission order not to transmit their respective secondary data frames, leading to interruption or failure of the transmission of data frames in the network 100.

In contrast, in the Transmit Opportunity Increment signal approach described above with reference to FIG. 6, the absence of a signal from a node in a given transmit opportunity window, whether due to failure of a node or because the node has no secondary data frame to transmit, is detected by the parent node 110, which transmits a Transmit Opportunity Increment signal to cause all the nodes to increment their transmit opportunity counters, such that subsequent nodes in the predefined secondary transmission order can continue transmit their secondary data frames in turn.

As illustrated in FIG. 6, if a transmit opportunity window (e.g. the transmit opportunity window 656) elapses within a predefined period before the scheduled transmission of the next TDM cycle beacon 202 (e.g. within 15 symbol times plus a predefined timing margin), the parent node 120 does not immediately transmit the Transmit Opportunity Increment signal, but instead delays transmission of the Transmit Opportunity Increment signal until after the end of the next microframe cycle, i.e. until the end of the primary data transmission interval 210 signalled by the next TDM cycle beacon 202. This ensures that a secondary data frame (e.g. data frame 624) cannot be transmitted onto the network bus 190 until after the microframes associated with the next TDM cycle beacon 202 (e.g. microframes 622), thus reducing the risk of collision between primary data and secondary data.

If the transmit opportunity counter of the parent node 110 reaches a predefined maximum value, equal to the total number of nodes coupled to the network bus 190, the parent node 120 does not transmit the Transmit Opportunity Increment signal, but will instead transmit a new data cycle beacon 412 of the kind described above in place of the next TDM cycle beacon 202, thus starting a new secondary data cycle and re-initialising the transmit opportunity counters of all the nodes 110-180.

As will be appreciated by those of ordinary skill in the art, incrementing transmit opportunity counters in the parent node 110 and child nodes 130-180 is one method that may be employed to maintain correct timing of transmission of secondary data frames by the nodes to ensure that each node transmits its secondary data at the correct point in the secondary data cycle, and other methods for maintaining correct secondary data frame timing may equally be employed.

For example, instead of initialising the transmit opportunity counters to zero and incrementing them in response to a Transmit Opportunity Increment signal transmitted by the parent node 110, the transmit opportunity counters of the nodes could be initialised to a value equal to the number of nodes coupled to the network bus 190, and could be decremented in response to a Transmit Opportunity Decrement signal transmitted by the parent node 110 on detection that a transmit opportunity window has elapsed without a secondary data frame being transmitted by a node.

As another example, the parent node 110 could transmit a symbol containing an identifier of a next node that is permitted to transmit a secondary data frame onto the network bus 190.

In some examples, the TDM cycle beacon and the data cycle beacon may be used to communicate clock sample rate information to the nodes 130-180.

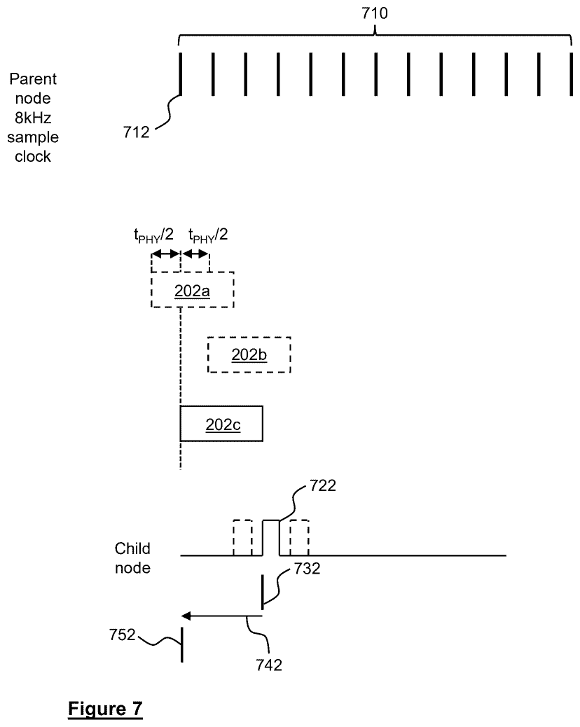

FIG. 7 is a schematic diagram illustrating recovery of an audio sample rate clock from the TDM cycle beacon.

As described above, a TDM cycle beacon 202 is periodically transmitted by the parent node 110, e.g. once every audio sample period, and the TDM cycle beacon 202 may be replaced by a data cycle beacon 412 once every node coupled to the network bus 190 has had an opportunity to transmit a secondary data frame during a secondary data cycle, as discussed above with reference to FIGS. 4-6. Accordingly, for an audio sample rate of 8 kHz, a TDM cycle beacon 202 or a data cycle beacon 412 is transmitted by the parent node 110 every 125 μs.

The parent node 110 may be configured to begin transmitting each TDM cycle beacon 202 and data cycle beacon 412 in synchronisation with an audio sample clock event (e.g. an audio cycle clock pulse), such that the beginning of each TDM cycle beacon 202 and data cycle beacon 412 is aligned in time with an audio sample clock event. These periodic beacon signals can be used by child nodes 130-180 to recover an audio sample clock for use as a clock signal for analog to digital converters (ADCs), digital to analog converters (DACs) and other components or subsystems of the child nodes 130-180 that require an audio sample clock.

On detecting a complete TDM cycle beacon 202 or a data cycle beacon 412 on the network bus 190, each child node 130-180 generates a TDM Cycle Beacon Detect pulse, which may be, for example, a single pulse going from logic 0 to logic 1. One TDM Cycle Beacon Detect pulse is generated for each detected TDM cycle beacon 202 or data cycle beacon 412. A train of such pulses forms a TDM Cycle Beacon Detect signal, which is supplied as a frequency and phase reference signal to a phase locked loop (PLL) of a clock recovery subsystem of the child device (e.g. the PLL 156 of the first microphone node 150A). The PLL outputs a clock signal that is frequency- and phase-locked to the TDM Cycle Beacon Detect signal. A phase adjustment may be applied by the clock recovery system to compensate for the duration of the TDM cycle beacon 202/data cycle beacon 412.

FIG. 7 shows a sequence of audio sample clock events of an audio sample clock of the parent node 110. A TDM cycle beacon 202 is transmitted by parent node 110 in synchronisation each of the audio sample clock events, but for clarity FIG. 7 shows only one TDM cycle beacon being transmitted in synchronisation with a first audio sample clock event 712.

The point in time at which a TDM cycle beacon 202 is actually transmitted may be offset, either positively or negatively, from a corresponding sample clock event due to delays that may be introduced by the physical layer interface 112 of the parent node, such that the TDM cycle beacon 202 may be transmitted earlier or later than the corresponding sample clock event. The maximum offset (positive or negative) may be referred to as t_{PHY}/2. FIG. 7 shows a TDM cycle beacon 202a that has been transmitted with the maximum positive offset, i.e. the earliest transmission timing for the TDM cycle beacon, a TDM cycle beacon 202b that has been transmitted with the maximum negative offset, i.e. the latest transmission timing for the TDM cycle beacon, and the average transmission timing of a TDM cycle beacon 202c.

Over the course of a plurality of audio sample clock periods, the transmission timing of TDM cycle beacons 202 and data cycle beacons 412 by the parent node 110 will tend towards the average transmission timing 202c shown in FIG. 7.

When the child node detects a complete TDM cycle beacon 202 or data cycle beacon 412 on the network bus 190, it outputs a TDM Cycle Beacon Detect pulse 722. As noted above a train of such pulses forms the TDM Cycle Beacon Detect signal that is supplied as a frequency and phase reference signal to the PLL of the clock recovery system of the child node.

The PLL filters jitter and outputs an output signal 732 having the average phase of the frequency and phase reference signal. A phase adjustment may then be applied by the clock recovery system, as indicated by the arrow 742 in FIG. 7 to generate a phase-adjusted audio sample clock event 752 at the child node.

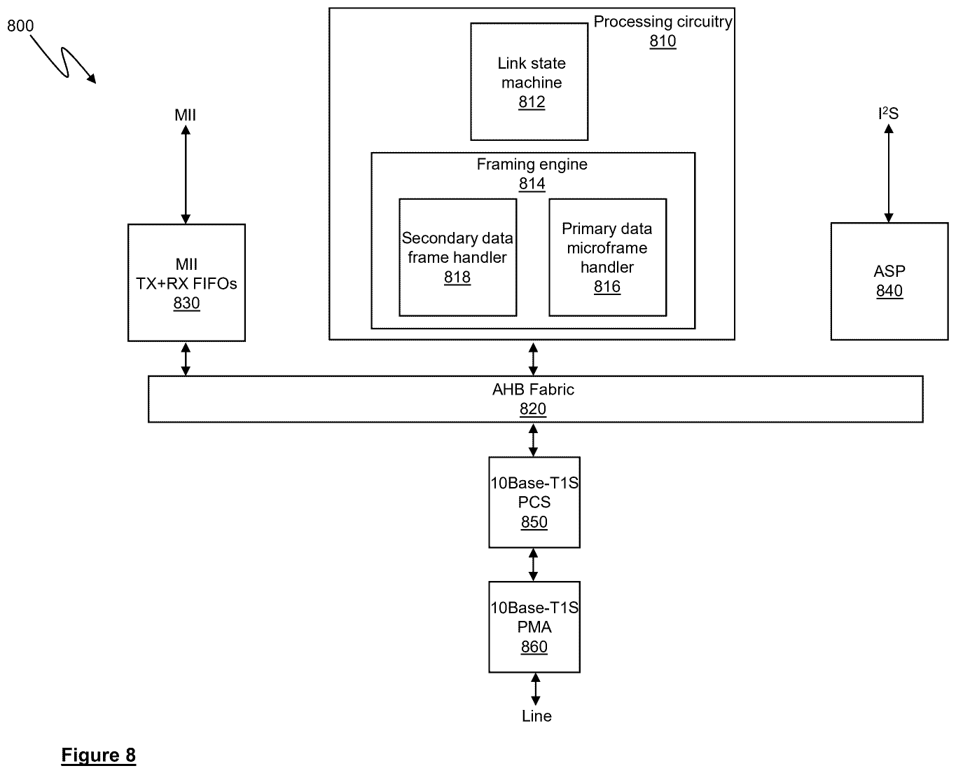

FIG. 8 is a schematic representation of an isochronous data transceiver system that may be included in nodes of a multi-drop communications network in which the system and method of the present disclosure may be implemented, e.g. in the parent node 110 and the child nodes 130-180 of the network 100 of FIG. 1.

The isochronous data transceiver system in this example is an audio transceiver system, which is shown generally at 800 in FIG. 8. However, it will be appreciated that the isochronous data transceiver system may be used for transmission and reception of other types of isochronous data.

The audio transceiver system 800 may be included in the physical layer interface 112 and/or the protocol logic 118 of the parent node 110 and in the physical layer interfaces, 132, 152, 182 and/or the protocol logic 134, 154, 184 of the respective child nodes 130-180, for example.

The audio transceiver system 800 in this example comprises processing circuitry 810 which implements (e.g. in firmware executed by the processing circuitry 810) a link state machine 812 and a framing engine 814. The processing circuitry 810 may comprise logic circuitry implementing a state machine, or a general purpose microprocessor or microcontroller executing suitable software or firmware, or any other discrete or integrated circuitry configured to implement the link state machine 812 and framing engine 814.

The framing engine 814 comprises a primary data (e.g. audio data) microframe handler 816 and a secondary data (e.g. Ethernet data) frame handler 818.

The audio transceiver system 800 further comprises an advanced high-performance bus (AHB) fabric 820, which is coupled to the processing circuitry 810 for bidirectional communication of data between the processing circuitry 810 and the AHB fabric 820.

A set of media independent interface (MII) FIFO (first in-first out buffers) 830 is also coupled to the AHB fabric 820 for bidirectional communication of secondary (e.g. Ethernet) data frames between the FIFOs 830 and the AHB fabric 820. The FIFOs 830 receive data from, and transmit data to, a MII of the node in which the audio transceiver system 800 is implemented (also referred to as the host node).

An audio serial port (ASP) 840 is implemented in the audio transceiver system 800 for bidirectional communication of audio data between the audio transceiver system 800 and external devices. The audio data may be, for example, example I²S (Inter-Integrated Circuit Sound).

The audio transceiver system 800 further includes a 10Base-T1S physical coding sublayer (PCS) 850 coupled to the AHB fabric 820 for bidirectional data communication between the AHB fabric 820 and the PCS 850, and a 10Base-T1S physical medium attachment (PMA) 860, coupled to the PCS 850 for bidirectional data transmission between the PCS 850 and the PMA 860. In use of the audio transceiver system 800, the PMA 860 is coupled to the network bus 190. The PCS 850 and the PMA 860 together provide interface circuitry for interfacing the audio transceiver system 800 with the network bus 190.

The MII FIFOs 830, in conjunction with the MII interface of the host node, provide a generic Ethernet interface for transmitting and receiving Ethernet data.

The secondary data frame handler 818 transmits and receives secondary data (e.g. Ethernet data) frames to and from the network bus 190 via the PCS 850 and PMA 860. Similarly, the primary data microframe handler 816 transmits and receives data microframes (e.g. containing audio data) to and from the network bus 190 via the PCS 850 and PMA 860. The framing engine 814 is configured to manage the multiplexing of data frames with microframes, including handling (e.g. generating and transmitting) the TDM cycle beacon 202 and the data cycle beacon 412 and PLCA frame transmit control.

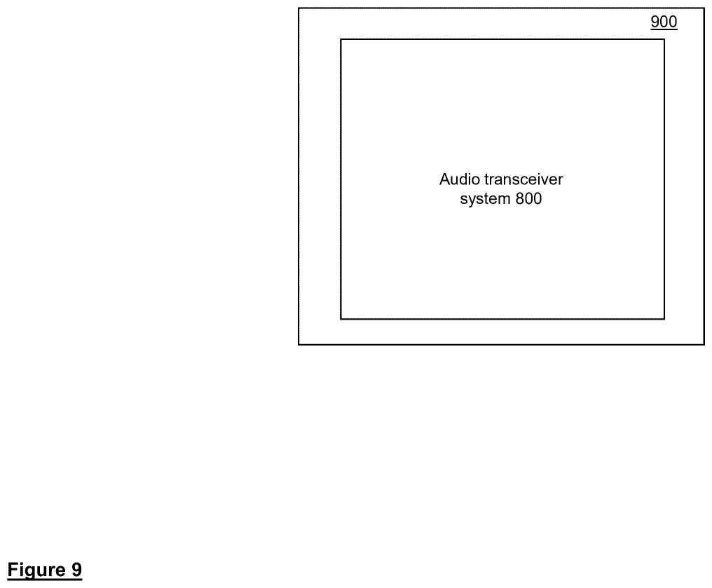

The audio transceiver system 800 may be implemented as a standalone integrated circuit (IC) such as an audio transceiver IC 900, as shown schematically in FIG. 9.

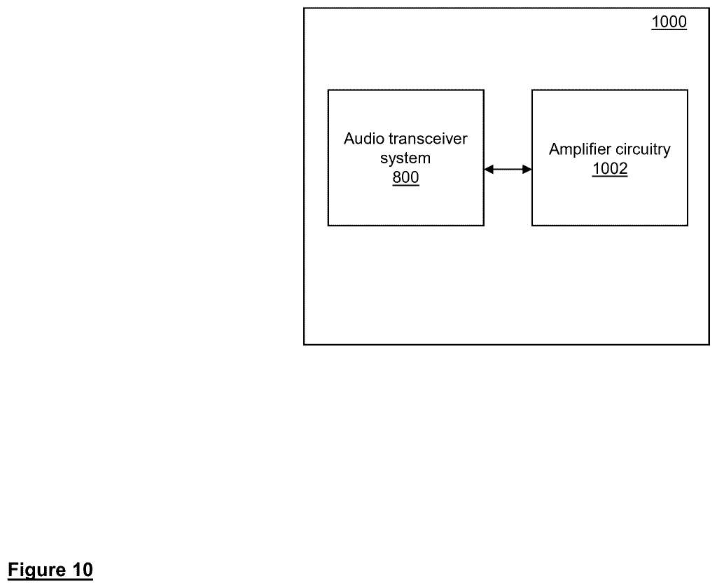

Alternatively, the audio transceiver system 800 may be combined with other circuitry in an IC. For example, the audio transceiver system 800 may be combined with amplifier circuitry 1002 in a combined amplifier and audio transceiver IC 1000, as shown schematically in FIG. 10.

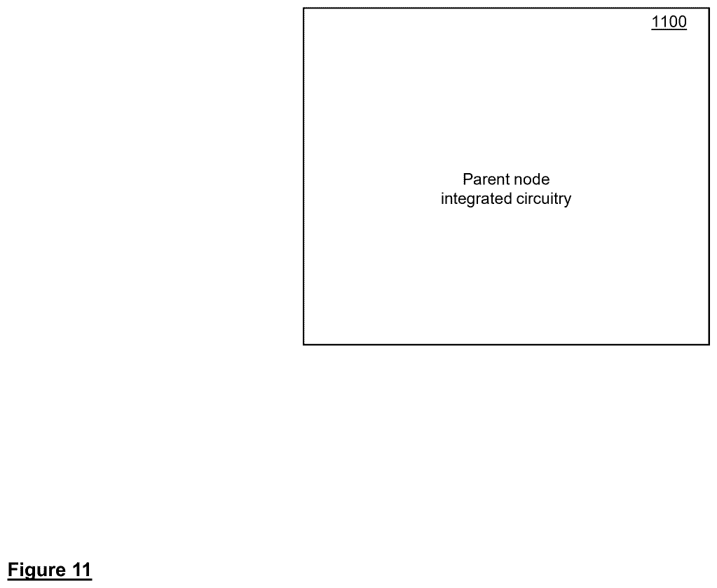

The parent node 110 may be implemented in integrated circuitry (e.g. a single integrated circuit or a System on Chip (SoC), as shown generally at 1100 in FIG. 11. The integrated circuitry 1100 may be configured to apply the random or pseudo-random delay to the transmission timing of the TDM cycle beacon 202, and to append the randomisation value to the TDM cycle beacon 202 as discussed above.

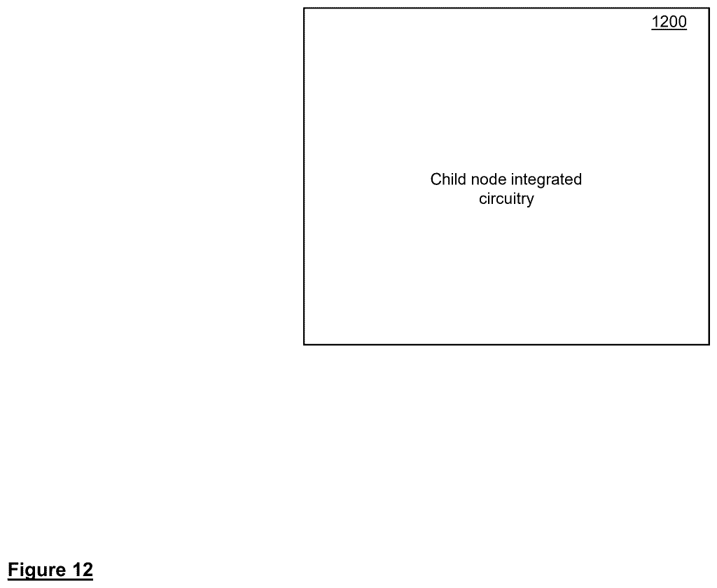

Each child node 130-180 may be implemented in integrated circuitry (e.g. a single integrated circuit or a System on Chip (SoC), as shown generally at 1200 in FIG. 12. The integrated circuitry 1200 may be configured to receive the TDM cycle beacon 202 and the appended randomisation value from the parent node 110, and to compensate for the randomised or pseudo-randomised transmission timing in phase locked loop (PLL) reference clock generation, as discussed above.

Further features of the system and method of the present disclosure are set out below

A system and method for a communications system, preferably a communications bus for an audio system, preferably for use in an automotive environment.

A system and method for a communications network, the system arranged to: transmit a network beacon on a network at regular intervals, to define a beacon cycle for the transmission of data, transmit primary data following the transmission of the network beacon, and transmit secondary data following the primary data, the secondary data transmitted within the remaining duration of the beacon cycle and preceding the transmission of the next network beacon.

Preferably, the primary data is low latency data, and the secondary data has more relaxed latency requirements than the primary data.

Preferably, the system is configured such that the latency bound for the primary data is approximately equivalent to one network beacon interval.

Preferably, the primary data comprises audio channel data. The audio channel data may comprise data output from system microphones or accelerometers, or for playback from system loudspeakers. The audio channel data may comprise data for use as part of a road noise cancellation system.

Alternatively, the primary data may comprise other non-audio low-latency data, which may be isochronous.

Preferably, the secondary data comprises network control data, e.g. Ethernet data.

Preferably, the transmission rate of the network beacon is based on the latency requirements for the low latency data. For example, for systems wherein the primary data is audio data, the transmission rate of the network beacon may be based on the audio sample rate.

Preferably, the communications network comprises at least one parent node, and a plurality of child nodes. Preferably, the communications network is configured as a multi-drop network, where multiple devices are connected to a single network bus.

Preferably, the secondary data comprises ethernet frames to be transmitted by devices on the network.

The ethernet frames may be transmitted across multiple beacon cycles, while not interrupting the regular transmission of the low-latency data following the network beacon transmission.

Preferably, the network beacon is selected from: a low-latency beacon to mark the start of primary data within a beacon cycle, or a data cycle beacon to mark the start of transmission of a frame cycle of secondary data on the network across a series of beacon cycles, in addition to marking the start of primary data within a beacon cycle.

It will be understood that the data cycle beacon may be provided as a special case of the low-latency beacon.

Preferably, the network nodes are configured to transmit a yield frame as the secondary data, for instances when the network node has no data to transmit.

Preferably, when all network nodes on the network have transmitted a yield frame, a data cycle beacon is transmitted as the next network beacon, to define the start of a new frame cycle of secondary data.

Preferably, the communications network comprises a multi-drop twisted pair bus, arranged for half-duplex data transmission.

Preferably, the primary data is transmitted as a microframe of data from a network node.

Preferably, the primary data comprises a header section to identify the microframe as distinct from a normal data frame, e.g. for the transmission of secondary data.

Preferably, the network beacon is used for the recovery and/or synchronisation of a system clock by network nodes of the system.

There is also provided a network node for use in the above-described communications network. The network node may be provided with a data port and a transceiver, the transceiver arranged to communicate with a network bus via the data port.

In one aspect, the network node is provided as an integrated circuit (or IC) comprising a transceiver module and data port as described above, and a secondary module arranged to output a signal based on data received by the transceiver module.

Preferably, the secondary module comprises an integrated amplifier module for driving a transducer, preferably an audio transducer or speaker. It will be understood that the integrated amplifier module may be arranged to drive a haptic transducer.

In an alternative aspect, the IC may be provided as a co-packaged transceiver module and amplifier module, for example if the transceiver module and the amplifier module are manufactured using different processes.

Alternatively, the network node may be provided as a standalone transceiver IC arranged to be coupled with a discrete secondary IC, e.g. a separate amplifier, an audio codec, a separate controller IC, etc.

Preferably, the network node comprises a phase-locked-loop (or PLL) arranged to generate a clock signal at the network node, wherein the clock signal is generated based on a network beacon received by the network node.

There is further provided a vehicle comprising the system and method as described above.

The system and/or integrated circuits described above with reference to the accompanying drawings may be incorporated in a vehicle, e.g. as part of an audio system or component of a car, truck boat or other vehicle, or as part of RNC system or component for a car, truck or other road vehicle, or in another host device such as an electronic musical instrument system or component, a commercial audio system or component, a sound reinforcement system or component, an industrial data communication system or component, a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD-or DVD-ROM, programmed memory such as read only memory (Firmware), or on a data carrier such as an optical or electrical signal carrier. For many applications embodiments of the invention will be implemented on a System on Chip (SoC), DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A system for transmission of primary and secondary data, the system comprising:
a bus;
a parent node coupled to the bus; and
a plurality of child nodes, each coupled to the bus,
wherein:
the parent node is configured to periodically transmit a time domain multiplexing (TDM) cycle beacon to the bus, wherein the TDM cycle beacon signals a start of a primary data transmission interval, and wherein the primary data transmission interval is a period reserved for transmission of primary data by the parent node and the plurality of child nodes;
the parent node and each of the plurality of child nodes are operable to, responsive to the TDM cycle beacon, transmit primary data for a current TDM beacon period associated with the TDM cycle beacon to the bus during the primary data transmission interval; and
the parent node and the plurality of child nodes are operable to transmit secondary data to the bus during a secondary data transmission interval between an end of the primary transmission interval and transmission by the parent node of a next TDM cycle beacon.

2. The system of claim 1, wherein the primary data is of a higher priority than the secondary data.

3. The system of claim 1, wherein the primary data is isochronous data associated with a first latency requirement and the secondary data is associated with a second latency requirement, wherein the first latency requirement is more stringent than the second latency requirement.

4. The system of claim 1, wherein the parent node is further configured to transmit a data cycle beacon in place of the TDM cycle beacon, wherein the data cycle beacon signals:
a start of a primary data transmission interval; and
a start of a secondary data frame cycle,
wherein the secondary data frame cycle provides an opportunity for the parent node and each of the plurality of child nodes to transmit one frame of secondary data to the bus.

5. The system of claim 2, wherein the primary data comprises audio data and the secondary data comprises Ethernet data.

6. The system of claim 5, wherein the parent node is configured to transmit one TDM cycle beacon per sample period of the audio data.

7. The system of claim 1, wherein the TDM cycle beacon comprises a first particular combination of symbols used in 10Base-T1S Ethernet.

8. The system of claim 1, wherein the parent node and each of the plurality of child nodes are each configured to transmit their primary data in a respective primary data microframe.

9. The system of claim 8, wherein the primary data microframe comprises:
a header;
one or more data samples of primary data for a current TDM beacon period; and
an end-of-frame delimiter; and, optionally,
a scrambler synchronisation sequence.

10. (canceled)

11. The system of claim 8, wherein the header comprises a second particular combination of symbols used in 10Base-T1S Ethernet.

12. The system of claim 8, wherein the parent node and the plurality of child nodes are configured to transmit their respective primary data microframes in a predefined primary data transmission order.

13. The system of claim 12, wherein the parent node and the plurality of child nodes are configured to implement a minimum delay between transmission of the TDM cycle beacon and transmission of the primary data frame of the parent node and between transmission of their respective primary data microframes in the predefined primary transmission order.

14. The system of claim 12, wherein the parent node and the plurality of child nodes are configured to implement a random or pseudo-random delay between transmission of their respective primary microframes.

15. The system of claim 12, wherein the parent node and each of the plurality of child nodes are operative to determine a correct point within the primary data transmission interval at which to transmit its primary data microframe by determining:
a byte or time offset from the TDM cycle beacon; or
a number of transmissions on the bus that have occurred since the transmission of the TDM cycle beacon.

16. The system of claim 4, wherein the parent node and each of the plurality of child nodes are operative to transmit a Yield signal to the bus if they do not have a frame of secondary data to transmit.

17. The system of claim 4, wherein:
the secondary data frame cycle provides a respective transmit opportunity window for the parent node and each of the plurality of child nodes within which the parent node or the child node may transmit one frame of secondary data to the bus; and
the parent node and each of the plurality of child nodes are each operative to maintain correct timing of transmission of their respective secondary data frames.

18. The system of claim 17, wherein:
the secondary data frame cycle provides a respective transmit opportunity window for the parent node and each of the plurality of child nodes within which the parent node or the child node may transmit one frame of secondary data to the bus;
the parent node and each of the plurality of child nodes includes a transmit opportunity counter operative to count transmit opportunities since the transmission of the data cycle beacon, wherein each of the plurality of child nodes is operative to determine when to transmit its respective frame of secondary data based on a value of its respective transmit opportunity counter;
the parent node and each of the plurality of child nodes is operative to adjust its respective transmit opportunity counter responsive to transmission of a frame of secondary data by the parent node or a child node;
each of the plurality of child nodes is operative to transmit no signal to the bus if it does not have a frame of secondary data to transmit;
the parent node is operative, on detection that a transmit opportunity window has elapsed without a frame of secondary data being transmitted, to transmit a Transmit Opportunity Increment signal to the bus; and
each of the plurality of child nodes is operative to adjust its respective transmit opportunity counter responsive to detection of a Transmit Opportunity Increment signal.

19. The system of claim 18, wherein:
the parent node is operative, if the transmit opportunity window will elapse within a predefined period before a scheduled transmission of a next TDM cycle beacon, to delay transmission of the Transmit Opportunity Increment signal until after the end of the primary data transmission interval of a next TDM cycle period associated with the next TDM cycle beacon; and/or
the parent node is operative, responsive to its transmit opportunity counter reaching a predefined value, not to transmit the Transmit Opportunity Increment signal and to transmit a new data cycle beacon in place of a next TDM cycle beacon.

20. (canceled)

21. The system of claim 4, wherein the data cycle beacon comprises a third particular combination of symbols used in 10Base-T1S Ethernet.

22. The system of claim 4, wherein a node transmitting a frame of secondary data is operative to split the frame of secondary data over a plurality of TDM beacon periods if a length of the frame of secondary data is greater than a length of the secondary data transmission interval.

23. The system of claim 22, wherein the node transmitting the frame of secondary data is operative to:
suspend transmission of the frame of secondary data; and
resume transmission of the frame of secondary data after the end of the primary transmission period of a next TDM beacon period.

24. The system of claim 23, wherein the node transmitting frame of secondary data is operative to suspend transmission of the frame of secondary data on an octet boundary thereof.

25. The system of claim 23, wherein the node transmitting the frame of secondary data is operative to:
transmit a suspend signal comprising a fourth particular combination of symbols used in 10Base-T1S Ethernet to signal suspension of the transmission of the frame of secondary data; and
transmit a resume signal comprising a fifth particular combination of symbols used in 10Base-T1S Ethernet in the next TDM beacon period to signal resumption of the transmission of the frame of secondary data.

26. The system of claim 4, wherein the parent node and the plurality of child nodes are configured to implement a random or pseudo-random delay to a transmission timing of their respective secondary data frames.

27. The system of claim 1, wherein the parent node is operative to apply a random or pseudo-random delay to a transmission of a TDM beacon signal.

28. The system of claim 27, wherein the parent node is operative to associate a randomisation value indicative of a duration of the random or pseudo-random delay with the TDM beacon signal.

29. (canceled)

30. The system of claim 4, wherein the parent node and/or at least one of the plurality of child nodes comprises a clock recovery system configured to generate a clock signal based on the TDM cycle beacon signal and/or the data cycle beacon.

31. The system of claim 30, wherein the clock recovery system is configured to generate a TDM Cycle Beacon Detect signal responsive to detection of the TDM cycle beacon or the data cycle beacon, wherein the clock recovery system comprises a phase-locked loop (PLL) configured to use the TDM Cycle Beacon Detect signal as a frequency and phase reference to generate the clock signal.

32-34. (canceled)

35. A road noise cancellation system comprising the system of claim 1, wherein at least one of the plurality of child nodes comprises a microphone node or an accelerometer node, and wherein the primary data comprises road noise cancellation audio sample data generated by the microphone node or accelerometer data generated by the accelerometer node.

36. A method for transmission of primary and secondary data in a communications network comprising a bus, a parent node coupled to the bus, and a plurality of child nodes coupled to the bus, the method comprising:
periodically broadcasting a TDM cycle beacon signal by the parent node, the TDM cycle beacon signal defining a start of a primary data transmission interval, wherein the primary data transmission interval is a period reserved for transmission of primary data by the parent node and the plurality of child nodes;
responsive to the TDM cycle beacon signal, the parent node and/or at least one of the plurality of child nodes transmitting primary data to the bus during the primary data transmission interval; and
providing a secondary data transmission interval between expiry of the primary data transmission interval and broadcast by the parent node of a next TDM cycle beacon signal, the secondary data transmission interval being a period reserved for transmission of secondary data by the parent nodes and/or the plurality of child nodes.

37. An isochronous data transceiver for a node of the system of claim 1, wherein the isochronous data transceiver comprises:
processing circuitry implementing a framing engine comprising a primary data microframe handler and a secondary data frame handler; and
interface circuitry for interfacing the isochronous data transceiver with the bus of the system,
wherein:
the primary data microframe handler is configured to transmit and receive primary data microframes to and from the bus via the interface circuitry;
the secondary data frame handler is configured to transmit and receive secondary data frames to and from the bus via the interface circuitry; and
the framing engine is operable to generate and transmit the TDM cycle beacon to the bus.

38. The isochronous data transceiver of claim 37, wherein the isochronous data transceiver is configured to receive the TDM cycle beacon and/or a data cycle beacon and to generate a clock signal based on the TDM cycle beacon signal and/or the data cycle beacon, and wherein optionally, the isochronous data comprises audio data.

39. (canceled)

40. An integrated circuit (IC) implementing the isochronous data transceiver of claim 37, wherein the IC optionally further comprises amplifier circuitry.

41. (canceled)

42. A parent node or a child node of a communications network comprising the isochronous data transceiver of claim 37.

43. Integrated circuitry integrating a parent node for the system of claim 1, wherein the integrated circuitry is operative to:
apply a random or pseudo-random delay to a transmission of a TDM beacon signal; and
associate a randomisation value indicative of a duration of the random or pseudo-random delay with the TDM beacon signal.

44. Integrated circuitry integrating a child node for the system of claim 1, wherein the integrated circuitry is operative to:
receive a TDM beacon signal having a random or pseudo-random delay and an associated randomisation value; and
generate a reference clock signal based on the received TDM beacon signal using the randomisation value to compensate for the random or pseudo-random delay of the beacon signal.

45. A vehicle comprising the system of claim 1.
